(19) United States
(12) Patent Application Publication
(10) Pub. No.: US 2024/0393776 A1
(43) Pub. Date: Nov. 28, 2024

(54) USING HOME TELEMATICS DATA TO IDENTIFY RECOMMENDATIONS ASSOCIATED WITH HOME WARRANTY PRODUCT COVERAGE

(71) Applicant: State Farm Mutual Automobile Insurance Company, Bloomington, IL (US)

(72) Inventors: Erin Ann Olander, Lincoln, IL (US); Andrew Joseph Zeglin, Normal, IL (US); Chris N. Kawakita, Bloomington, IL (US)

(21) Appl. No.: 16/158,513

(22) Filed: Oct. 12, 2018

Related U.S. Application Data
(60) Provisional application No. 62/579,998, filed on Nov. 1, 2017.
(60) Provisional application No. 62/577,378, filed on Oct. 26, 2017.
(60) Provisional application No. 62/573,299, filed on Oct. 17, 2017.

(51) Int. Cl. G05B 23/02; G01R 21/133; H02J 3/14

(52) U.S. Cl. CPC G05B 23/0254; G01R 21/133; G06Q 40/08; H02J 3/144; G01R 22/10; H02J 2310/14

(57) ABSTRACT

Techniques are disclosed to monitor home telematics data to identify the overall health of home devices to be covered, or that are currently covered, by a home warranty. The home telematics data may include information relating to the electrical usage of various home devices, which may be obtained via an electrical monitoring (EM) device. Using the home telematics data, a home warranty provider may identify the current health of home devices, identify signs of early failure, suggest recommended preventative maintenance, and/or allocate a portion of the premium payments to carrying out the preventative maintenance. Thus, by leveraging collected home telematics data and tracking this data over time, a home warranty provider may accurately price home warranties, mitigate risk, and potentially prevent costlier claims by anticipating and addressing issues before repairs are needed.

### CROSS REFERENCE TO RELATED APPLICATIONS

This application claims the benefit of (1) U.S. Provisional Patent Application No. 62/573,299, entitled “Using Home Telematics Data for Issuing Home Warranties,” filed Oct. 17, 2017; (2) U.S. Provisional Patent Application No. 62/577,378, entitled “Using Home Telematics Data for Issuing Home Warranties,” filed Oct. 26, 2017; and (3) U.S. Provisional Patent Application No. 62/579,998, entitled “Using Home Telematics Data for Issuing Home Warranties,” filed Nov. 1, 2017, the disclosure of each of which is hereby expressly incorporated by reference herein in its entirety.

### FIELD OF THE DISCLOSURE

The present disclosure relates generally to home warranties and, more particularly, to implementing home telematics data to accurately assess and mitigate home warranty risk.

### BACKGROUND

In many cases, a homeowner may purchase a home warranty to cover the replacement or repair cost for various home devices, should such devices fail. For instance, home devices covered by a home warranty may include kitchen appliances, HVAC equipment, sump pumps, water heaters, etc. Traditionally, a home warranty may be priced based upon the number and/or type of home devices for which coverage is sought, as well as the total monetary amount of coverage.

However, for the sake of efficiency, home inspections may not generally be carried out, and therefore a home warranty provider may not be aware of the overall condition of the home devices to be covered by the warranty. Therefore, the home warranty premium pricing may not adequately reflect the risk absorbed by the home warranty provider in many cases. For example, if the same amount of coverage is sought by two different homeowners, each may pay the same amount regardless of the age, use, and maintenance performed on each set of home devices. As a result, traditional home warranties may be issued in a manner that results in several drawbacks.

### BRIEF SUMMARY

Home telematics data may be remotely collected for one or more home devices that are to be, or currently are, associated with a home warranty. The home telematics data may be generated by various components within, or associated with, the home, such as smart appliances, televisions, home monitoring systems, smart home control systems, alarm systems, electricity monitoring (EM) devices, etc. Regardless of the number and type of devices providing the home telematics data, the home telematics data may reveal information regarding the use of home devices and/or diagnostic data associated with the home devices, as further discussed herein.

The home telematics data may also be collected, aggregated, and/or analyzed over time via one or more backend components associated with a home warranty provider, for example. By collecting and monitoring the home telematics data over time, a home warranty provider may assess the initial health of each home device to be covered by a home warranty to generate an energy profile, which may be used to calculate an initial home warranty premium (i.e., home warranty rate) that accurately reflects the present risk of covering the various home items. Moreover, the home warranty provider may continue to monitor the home telematics data over time, and adjust the home warranty premiums upon renewal using updated energy profiles.

Furthermore, the home warranty provider may also leverage the home telematics data to identify if and when specific home devices are likely to fail, and may notify the homeowner of preventative maintenance steps that may be taken to prevent failure of the covered home devices. In this way, the need to file a claim (for what may be a much larger monetary sum compared to the cost of performing the preventative maintenance) may be eliminated. With this in mind, some embodiments may include the home warranty provider prioritizing preventative maintenance periodically or continuously to provide recommendations to the homeowner using the home telematics data. And because preventative maintenance helps mitigate loss for both the homeowner and the home warranty provider, certain embodiments include the home warranty provider allocating a portion of the premium to specific categories of preventative maintenance. The allocation and/or categories may also be updated using home telematics data monitoring.

In one aspect, a computer-implemented method of determining recommendations associated with a home warranty may be provided. The method may include: (1) collecting, via one or more processors, home telematics data over an initial time period, the home telematics data being indicative of electricity consumption of one or more home devices during the initial time period that are to be covered by a home warranty; (2) calculating, via the one or more processors, a likelihood of whether each of the one or more home devices will fail within a projected future time period based upon the collected home telematics data, the projected future time period occurring subsequent to the initial time period; (3) determining, via the one or more processors, whether each respective calculated likelihood exceeds a threshold likelihood; (4) for each calculated likelihood that exceeds the threshold likelihood, determining, via the one or more processors, one or more recommendations to reduce each calculated likelihood below the threshold likelihood; and/or (5) transmitting, via the one or more processors, the one or more recommendations to a computing device associated with a customer having purchased the home warranty. The method may include additional, less, or alternate actions, including those discussed elsewhere herein.

In another aspect, a home warranty assessment engine may be provided. The home warranty assessment engine may include (1) a communication unit configured to collect home telematics data over an initial time period, the home telematics data being indicative of electricity consumption of one or more home devices during the initial time period that are to be covered by a home warranty; and/or (2) a processor unit configured to: (a) calculate a likelihood of whether each of the one or more home devices will fail within a projected future time period based upon the collected home telematics data, the projected future time period occurring subsequent to the initial time period; (b) determine whether each respective calculated likelihood exceeds a threshold likelihood; and/or (c) for each calculated likelihood that exceeds the threshold likelihood, determine one or more recommendations to reduce each calculated likelihood below the threshold likelihood. Additionally or alternatively, the communication unit may be configured to transmit the one or more recommendations to a computing device associated with a customer having purchased the home warranty. The home warranty assessment engine may include additional, less, or alternate components, including those discussed elsewhere herein.

In yet another aspect, a non-transitory computer readable media may be described having instructions stored thereon that, when executed by one or more processors, cause the one or more processors to: (1) collect home telematics data over an initial time period, the home telematics data being indicative of electricity consumption of one or more home devices during the initial time period that are to be covered by a home warranty; (2) calculate a likelihood of whether each of the one or more home devices will fail within a projected future time period based upon the collected home telematics data, the projected future time period occurring subsequent to the initial time period; (3) determine whether each respective calculated likelihood exceeds a threshold likelihood; (4) for each calculated likelihood that exceeds the threshold likelihood, determine one or more recommendations to reduce each calculated likelihood below the threshold likelihood; and/or (5) transmit the one or more recommendations to a computing device associated with a customer having purchased the home warranty. The non-transitory computer readable media may include additional, less, or alternate instructions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 is a block diagram of an exemplary home telematics data monitoring system 100 (“system 100”) in accordance with one aspect of the present disclosure;

FIG. 2 is a block diagram of an exemplary home warranty assessment engine 200 in accordance with one aspect of the present disclosure;

FIG. 3 illustrates an exemplary computer-implemented method 300 of using home telematics data to price home warranty premiums in accordance with one aspect of the present disclosure;

FIG. 4 illustrates an example computer-implemented method 400 of using home telematics data to determine recommendations to reduce the likelihood of failure of one or more covered home devices in accordance with one aspect of the present disclosure;

FIG. 5 illustrates an exemplary computer-implemented method 500 of using home telematics data to prioritize recommendations for preventative maintenance in accordance with one aspect of the present disclosure;

FIG. 6 illustrates an exemplary computer-implemented method 600 of using home telematics data to allocate a portion of a home warranty premium into preventative maintenance categories in accordance with one aspect of the present disclosure;

FIG. 7 illustrates an exemplary home warranty premium allocation 700 showing example preventative maintenance categories in accordance with one aspect of the present disclosure; and

FIGS. 8A-8B illustrate an exemplary mobile computing device application screen 800 in accordance with one aspect of the present disclosure.

The Figures depict preferred embodiments for purposes of illustration only. Alternative embodiments of the systems and methods illustrated herein may be employed without departing from the principles of the invention described herein.

### DETAILED DESCRIPTION

The present embodiments relate to, inter alia, monitoring home telematics data to identify the overall health of home devices to be covered, or that are currently covered, by a home warranty. The home telematics data may include information relating to the electrical usage of various home devices, which may be obtained via an electrical monitoring (EM) device. Using the home telematics data, a home warranty provider may identify the current health of home devices, identify signs of early failure, suggest recommended preventative maintenance, and/or allocate a portion of the premium payments to carrying out the preventative maintenance. Thus, by leveraging collected home telematics data and tracking this data over time, a home warranty provider may accurately price home warranties, mitigate risk, and potentially prevent costlier claims by anticipating and addressing issues before repairs are needed.

### Exemplary System

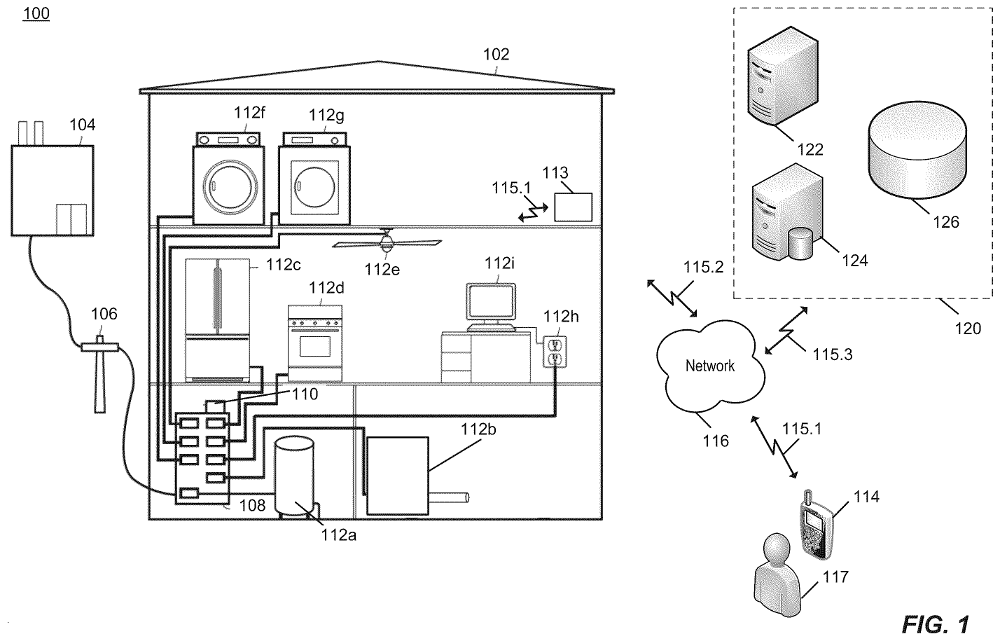

FIG. 1 is a block diagram of an exemplary home telematics data monitoring system 100 (“system 100”) in accordance with one aspect of the present disclosure. System 100 may include a home 102, which may be powered by electricity received in any suitable manner. For example, the home 102 may receive power from a power plant 104 via an electrical power grid 106. To provide other examples, the home 102 may receive power via generators, solar power systems, etc., which are not shown in FIG. 1 for purposes of brevity. The electricity may be routed (e.g., via a hot wire) to an electrical distribution board (also known and referred to as a “breaker box” or “breaker panel”) 108, which is generally located within or about the home 102. The electrical distribution board 108 may further divide the received electricity among several separate circuits, each circuit delivering electricity to one or more home devices (e.g., home devices 112a-112i) associated with the home 102.

As shown in FIG. 1, the electricity may be delivered to the one or more home devices 112.a-112.i via the electrical distribution board 208. Although only a few home devices are shown in FIG. 1, the home 102 may be associated with any suitable number of home devices, each operating from electrical power delivered via the electrical distribution board 108. For instance, the home devices 112a-112i may include an electric water heater 112a, an electrically powered HVAC system 112b, a refrigerator 112c, a stove 112d, a lighting fixture 112e, a washer 112f, a dryer 112g, an electrical outlet 112h, to which another one or more electric device, such as a television 112i, may be connected, etc. To provide additional examples, the home 102 may include other electric devices such as sensors, appliances, utility systems, electronics, alarm systems, smart home controllers, etc., which may or may not operate using power delivered via the electrical distribution board 108 (e.g., some devices may be battery operated), and which may not be shown in FIG. 1 for purposes of brevity.

### Exemplary Electricity Monitoring (EM) Device & Energy Profile

In some embodiments, one or more of the home devices 112a-112i may be uniquely identified with an electrical signature that is specific to each respective device. In other words, transmission of electricity to the refrigerator 112c (and/or other electrical activity associated with the refrigerator 112c), for example, may be differentiated from transmission of electricity to the stove 112d. Furthermore, transmission of electricity to the television 112i via the electrical outlet 112h (and/or other electrical activity associated with the television 112i and/or outlet 112h), for example, may be differentiated from transmission of electricity to another recipient electric device (e.g., a cable box) via the same electrical outlet 112h.

In some embodiments, an electricity monitoring (EM) device 110 may be affixed to or situated near the electrical distribution board 108. Generally, the EM device 110 may utilize the unique, differentiable electrical signatures of the home devices 112a-112i by wirelessly (and/or via wired connection to the electrical distribution board) monitoring electrical activity including the transmission of electricity via the electrical distribution board 108 to one or more of the home devices 112a-112i. Monitoring of electricity delivered to an electric device receiving the electricity may include, for example, monitoring the time at which the electricity was transmitted, the duration for which the electricity was transmitted, the magnitude of the electric current in the transmission, etc. In various embodiments, any suitable information obtained from the aforementioned electricity monitoring via EM device 110 may be part of the home telematics data or equivalent to the home telematics data collected by the home warranty provider, as discussed further herein.

Based upon the unique electrical signatures of each of the home devices 112a-112i, the monitored electrical activity may be correlated with each of the respective electric home devices 112a-112i receiving the electricity transmitted via the electrical distribution board 108. Further, electrical activity associated with other components of the home's electrical system (e.g., the electrical distribution board 108 or wiring about the home 102) may be correlated with one or more electric devices to which the electrical activity also pertains. In some embodiments, the EM device 110 may perform the correlation and/or other functions described herein, via one or more processors of the EM device 110 that may execute instructions stored at one or more computer memories of the EM device 110.

In other embodiments, the EM device 110 may monitor and record the electrical activity, and the correlation and/or other functions described herein may be performed via another system (e.g., one or more of backend components 120, as further discussed herein). In such a case, data indicative of monitored electricity and/or other data may be received directly via the EM device 110 and/or through via network communications (e.g., via EM device 110 communicating via the Internet and, in turn with backend components 120 via communication network 116). In any case, the correlation of the electrical activity with the respective electrical devices may produce home telematics data indicating, for example, the time, duration, and/or magnitude of electricity consumption by each of the electric devices 112a-112i during any suitable period of electrical activity monitoring.

Based upon at least the home telematics data, an energy profile may be generated and stored locally on the EM device 110 and/or transmitted to and stored on one or more of backend components 120 (or other suitable external computing devices). Again, the energy profile may include, for example, an identification of each of the electric devices 112a-112i and/or home telematics data indicative of the operation of each respective home device monitored via the EM device 110 during a particular time period and/or other diagnostic information associated with each respective home device. For example, the energy profile may include home telematics data that identifies a historical usage of each home device such as previous operation and/or trends, etc. Historical usage information may indicate a time of day, a day of the week, the time of the month, etc., during which a home device frequently uses electricity (e.g., lighting fixture 112e may not use electricity during late night hours of the day). As another example, historical usage may include the home device's total electricity consumption or usage rate over a period of time. Moreover, diagnostic information may be obtained via home telematics data collected via the EM device 110, and may include data indicating past events regarding a home device (e.g., breakdowns, power losses, arc faults, etc.).

Additionally or alternatively, the energy profile may include home telematics data that indicates expected or baseline electricity consumption for one or more home devices 112a-112i. For example, in the case of a refrigerator 112c, the refrigerator 112c's electricity consumption during a first monitoring period may be used to approximate expected electricity consumption during a subsequent monitoring period.

Further, the energy profile may include home telematics data pertaining to the home 102 as a whole. For example, the energy profile may include home telematics data reflecting the total, average, or rate of home electricity usage over a period of time. As another example, the energy profile may include information indicating times during which the home 102 as a whole uses more or less electricity. Further, the energy profile may include home telematics data that indicates specific types, classes, or specifications of electric devices that behave differently or consume a different amount of electricity compared to other electric devices within the home 102. Further, the energy profile may include home telematics data that indicate specific risks determined to be relevant to one or more of the home devices 112a-112i or to the home 102 as a whole, based upon the electrical activity of the electric devices 112a-112i.

Again, in some embodiments, the system 100 may include one or more smart components or other home devices not shown in FIG. 1. For example, a smart home controller may be present about the home 102, and at least one of the home devices within the home 102 may be a smart device (e.g., a smart appliance or a smart vehicle). The smart home controller may further be in communication with one or more sensors that may be located in or otherwise associated with home devices and/or other fixtures about the home 102. Such sensors and smart devices may transmit home telematics data to the smart home controller (e.g., usage data, error signals, etc.) that, alone or combined with the functions of the EM device 110 discussed herein, may produce further indication of electrical activity about the home 102. The smart home controller may be configured for wireless communication with each sensor and/or associated item interconnected with a smart home system or wireless network (e.g., the system 100 of FIG. 1).

Accordingly, the energy profile may be generated based upon a broad collection of various types of home telematics data associated with the home 102. As used throughout the disclosure, the term “home telematics data” may include, for example, the aforementioned electrical monitoring information obtained via the EM device 110, appliance usage data received from smart devices and/or sensors, vehicle telematics data received from a smart and/or autonomous vehicle, mobile device telematics data (e.g., positioning data) received from a mobile device associated with an occupant of the home 102 (e.g., mobile computing device 114), and/or any other suitable type data described herein that may be used to generate an energy profile used to accurately assess the state of various home devices over time, which may be used for various functions associated with a home warranty.

### Exemplary Communications of Components within System

In various embodiments, the home telematics data may be received at the EM device 110, at some other home device, and/or transmitted to a remote device to build the energy profile. For example, the EM device 110 may function as a consolidated device that, in addition to the electrical monitoring information associated with each of the home devices 112a-112i, wirelessly receives additional home telematics data from other home devices, including or in addition to the home devices 112a-112i, as discussed above. To provide another example, a smart home controller (not shown) may communicate with EM device 110 and/or other home devices associated with the home 102 to collect home telematics data, generate and store the energy profile, and transmit the energy profile to one or more backend components 120 via communication network 116. To provide yet another example, a suitable communication device, such as access point (AP) 113, for example, may receive home telematics data from the EM device 110 and/or other home devices associated with the home 102 and transmit the home telematics data to one or more backend components 120, which may in turn generate the energy profile and store the energy profile for further analysis, as discussed herein.

To facilitate such communications, the system 100 may include various components configured to communicate with other components within and remote to the home 102. For example, as mentioned above, the home may include an AP 113, which may communicate locally with one or more of home devices 112a-112i, EM device 110, and/or other home devices not shown in FIG. 1. In doing so, the AP 113 may receive and/or transmit data (e.g., home telematics data) in accordance with any suitable number and/or type of wired and/or wireless links, which may be represented as link 115.1, as shown in FIG. 1. Additionally or alternatively, the AP 113 may be configured to communicate with one or more backend components 120 via communication network 116 using any suitable number of wired and/or wireless links, which may be represented as link 115.2, as shown in FIG. 1. For example, AP 113 may be configured to communicate with one or more backend components 120 via a connection to the Internet. In embodiments in which the EM device 110 and/or other home devices 112a-112i communicate with the one or more backend components 120 without communicating with AP 113, link 115.2 may alternatively represent such communications.

Again, system 100 may further include a mobile computing device 114, which may be implemented as any suitable computing device, such as a mobile device (e.g., smartphone, tablet, laptop, phablet, netbook, notebook, pager, personal digital assistant (PDA), wearable computing device, smart glasses, smart watch or bracelet, etc.), or other computing device capable of wireless communication or data transmission. In one aspect, mobile computing device 114 may be configured with suitable hardware and/or software (e.g., one or more applications, programs, files, etc.) to communicate with one or more backend components 120 and/or other components associated with the home 102 (e.g., EM device 110, AP 113, home devices 112a-112i, etc.) via communication network 116 using any suitable number of wired and/or wireless links, which may be represented as links 115.1-115.3, as shown in FIG. 1.

In the present aspects, communication network 116 may be implemented as any suitable network configured to facilitate communications between mobile computing device 114, one or more home devices associated with the home 102, and/or one or more of backend components 120. Communication network 116 may facilitate data communications in accordance with any suitable number and/or type of compatible communication protocols. Thus, links 115.1, 115.2, and 115.3 may represent wired links, wireless links, or any suitable combination thereof. For example, communication network 116 may include one or more telecommunication networks, nodes, and/or links used to facilitate data transfers, and may facilitate a connection to the Internet for devices connected thereto. Accordingly, communication network 116 may represent any suitable number and/or type of interconnected network components that form an aggregate network system, such as dedicated access lines, plain ordinary telephone lines, satellite links, cellular base stations, public switched telephone networks (PSTN), a wireless telephony network (e.g., GSM, CDMA, LTE, etc.), a Wi-Fi network (e.g., via one or more IEEE 802.11 Standards), a WiMAX network, a proprietary network, a secure public internet, a mobile-based network, a virtual private network, etc., or any suitable combination thereof.

### Exemplary Backend Components

Backend components 120 may include any suitable number of components configured to receive data from and to send data to one or more home devices associated with the home 102, one or more of backend components 120, and/or mobile computing device 114 via communication network 116 using any suitable number of wired and/or wireless links, and in accordance with any suitable number and type of communication protocols. Backend components 120 may be configured to execute one or more applications to facilitate one or more aspects of the disclosure as further discussed herein. Backend components 120 may include one or more external computing devices such as server 122, a database server 124, and/or a database 126.

Furthermore, although FIG. 1 illustrates backend components 120 as incorporating three different types of backend components, backend components 120 may include any suitable number and/or type of backend components to facilitate the appropriate functions of the aspects as described herein. For example, although illustrated as single devices in FIG. 1, one or more portions of server 122, database server 124, and/or database 126 may be implemented as devices that share the same physical location or as one or more devices spanned across different locations as a shared database structure (e.g. cloud storage). In the present aspects, one or more other backend components 120 may communicate with one another to store data to and/or read data from one another as needed to facilitate the appropriate functions of the aspects as described herein.

For example, server 122 may be implemented as any suitable number and type of web servers, computer servers, etc., configured to provide communications to mobile computing device 114, one or more home devices associated with the home 102, and/or one or more of backend components 120. Additionally or alternatively, server 122 may be implemented to process application programming interface (API) service calls, to support one or more applications installed on mobile computing device 114, and/or to provide enhanced home warranty functionality, as further discussed herein. To provide another example, database server 124 may be implemented as any suitable number and type of servers configured to access data from database 126, which may be configured to store any suitable type of relevant data as described in the aspects herein related to the operation of system 100. For example, database 126 may store collected home telematics data, energy profiles, customer information, home warranty information, etc., the details of which are further discussed below.

In the present aspects, the one or more backend components 120 may receive home telematics data from the various sources as described above, and use the home telematics data to generate an energy profile that is associated with the entire home or each of the home devices 112a-112i. Again, this energy profile may be used as a baseline for future comparisons once enough home telematics data is collected. In one aspect, a user 117, who may be a potential or existing home warranty customer, for example, may request a quote for a new home warranty covering the home products 112a-112i. The user 117 may request this information via the mobile computing device 114, for example, or via any other suitable techniques. In any event, upon receiving a request for a new home warranty, a home warranty provider associated with the backend components 120 may initiate a trial monitoring period of home telematics data associated with the home devices 112a-112i.

For example, a home warranty provider may lease, sell, and/or facilitate installation of the EM device 110, and then collect home telematics data via the EM device 110 (and/or any other suitable devices) during an initial trial period (e.g., 1-2 weeks). At the end of this trial period, the energy profiles associated with the home 102 and/or each of the home devices 112a-112i may be analyzed to ascertain any abnormalities within the trial period as indicated by the home telematics data included in the energy profile(s). In this way, an initial health snapshot of each of the covered home devices may be obtained before the home warranty provider calculated a home warranty price and term for the user 117. In other words, the energy profile allows the home warranty provider to assess the likelihood of covering each home device based upon the likelihood of each device requiring repair or replacement over the term of the home warranty, and to price the premium in a manner that considers the risk identified by this information.

Assuming that the user purchases a home warranty, certain aspects also include the home warranty provider continuing to monitor the home telematics data to provide enhanced services to the user 117. For example, the home warranty provider may determine, during the term of the home warranty, that one of the covered home products 112a-112i will likely fail based upon anomalies identified in the energy profile for that particular home device. In this case, the home warranty provider may then identify recommendations for the user 117, and notify the user 117 accordingly of steps to take to mitigate this failure.

To provide an additional example, the home warranty provider may prioritize

preventative maintenance based upon changes in the energy profile for each home device over time, and notify the user 117 of these priorities. In this way, it may be ensured that a user takes the most effective action to mitigate risk for the home warranty provider.

To provide yet another example, the home warranty provider may allocate a portion of the premium payment to an account associated with preventative maintenance, which may be adjusted as home telematics data is further monitored. For instance, the home warranty provider may allocate 10% of the home warranty premium payment each month to different preventative maintenance categories, which may be re-allocated over time based upon an analysis of the energy profiles.

The one or more backend components may also transmit notifications regarding the aforementioned information to the mobile computing device 114. The details associated with these added home warranty functions are further discussed below.

### Exemplary Home Warranty Assessment Engine

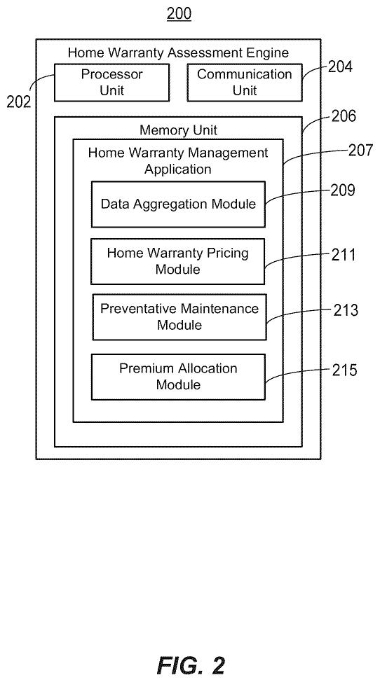

FIG. 2 is a block diagram of an exemplary home warranty assessment engine 200 in accordance with one aspect of the present disclosure. In the present aspects, home warranty assessment engine 200 may include a processor unit 202, a communication unit 204, and a memory unit 206, which may be interconnected with one another or otherwise configured to work in conjunction with one another to facilitate the functionality of the various aspects described herein.

Although each of the components in FIG. 2 are illustrated as separate units or modules, any components integrated as part of home warranty assessment engine 200 may be combined and/or share functions. For example, processor unit 202, communication unit 204, and memory unit 206 may be integrated as a single processing unit. Furthermore, although connections are not shown between the individual components of home warranty assessment engine 200, home warranty assessment engine 200 may implement any suitable number of wired and/or wireless links to facilitate communication and interoperability between these components.

For example, memory unit 206 and/or communication unit 204 may be coupled via wired buses and/or wireless links to processor unit 202 to facilitate communications between these components and to enable these components to accomplish their respective functions as described throughout the present disclosure. Additionally, although FIG. 2 depicts a single processor unit 202, communication unit 204, and memory unit 206, home warranty assessment engine 200 may include any suitable number of such components.

Home warranty assessment engine 200 may be affiliated or otherwise associated with a home warranty provider. Home warranty assessment engine 200 may include any suitable number of components configured to receive data from and/or send data to one or more devices, such as those discussed with reference to FIG. 1, for example. For instance, home warranty assessment engine 200 may be configured to communicate with the one or more home devices 112a-112i, the EM device 110, the mobile computing device 114, etc., via communication network 116 to receive, collect, store, and/or aggregate home telematics data using any suitable number of wired and/or wireless links. In various embodiments, home warranty assessment engine 200 may constitute a portion of (or the entirety of) one or more backend components (e.g., one or more backend components 120, as shown in FIG. 1), and may be configured (alone or in conjunction with other backend components) to execute one or more applications to perform one or more functions associated with the various aspects as discussed herein. To provide an illustrative example, home warranty assessment engine 200 may be implemented, for example, as any suitable number and/or type of servers (e.g., server 122).

Home warranty assessment engine 200 may be configured to access data from one or more additional data sources and/or store data to one or more storage devices. For example, home warranty assessment engine 200 may communicate with one or more external computing devices such as servers, databases, database servers, web servers, etc. The present aspects may include home warranty assessment engine 200 working in conjunction with any suitable number and/or type of backend components to facilitate the appropriate functions of the aspects as described herein.

Communication unit 204 may be configured to facilitate data communications between home warranty assessment engine 200 and communication network 116 in accordance with any suitable number and/or type of communication protocols. The communication unit 204 may be implemented with any suitable combination of hardware and/or software to facilitate this functionality. For example, communication unit 106 may be implemented with any suitable number of wired and/or wireless transceivers, network interfaces, physical layers (PHY), ports, antennas, etc.

Additionally or alternatively, communication unit 204 may be configured to facilitate data communications directly and/or indirectly between home warranty assessment engine 200 and one or more devices as discussed herein (e.g., the one or more home devices 112a-112i, the EM device 110, the mobile computing device 114, etc.). In the present aspects, communication unit 204 may be configured to facilitate data communications based upon the particular component and/or network with which home warranty assessment engine 200 is communicating.

Such communications may facilitate, for example, receiving home telematics data from the various devices as discussed herein and/or the transmission of various types of information. To provide an illustrative example, communication unit 204 may be configured to receive home telematics data from the one or more home devices 112a-112i, the EM device 110, the mobile computing device 114, etc., and to transmit notifications to a device associated with a home warranty customer (e.g., mobile computing device 114).

Processor unit 202 may be implemented as any suitable type and/or number of processors, such as a host processor for the relevant device in which home warranty assessment engine 200 is implemented, for example. Processor unit 202 may be configured to communicate with one or more of communication unit 204 and/or memory unit 206 to send data to and/or to receive data from one or more of these components. For example, processor unit 202 may be configured to communicate with memory unit 206 to store data to and/or to read data from memory unit 206.

In accordance with various embodiments, memory unit 206 may be a computer-readable non-transitory storage device, and may include any combination of volatile (e.g., a random access memory (RAM)), or a non-volatile memory (e.g., battery-backed RAM, FLASH, etc.). In the present aspects, memory unit 206 may be configured to store instructions executable by the processor unit 202. These instructions may include machine readable instructions that, when executed by the processor unit 202, cause the processor unit 202 to perform various acts.

In the present aspects, home warranty management application 207 is a portion of memory unit 206 configured to store instructions, that when executed by the processor unit 202, cause the processor unit 202 to perform various acts in accordance with applicable aspects as described herein. For example, instructions stored in home warranty management application 207 may facilitate the processor unit 202 performing functions such as receiving (periodically, continuously, in real-time, etc.) various types of data (e.g., home telematics data), generating energy profiles, calculating a likelihood that home devices covered by (or to be covered by) a home warranty will need to be repaired or replaced within a future time period, calculating a level of risk associated with the calculated likelihood, calculating a home warranty premium for the calculated level of risk, and/or transmitting the calculated home warranty premium to a suitable computing device.

Additionally or alternatively, instructions stored in the home warranty management application 207 may facilitate the processor unit 202 performing functions such as determining and/or transmitting one or more recommendations to reduce the likelihood of failure of one or more home devices, prioritizing preventative maintenance associated with one or more home devices, and/or transmitting an indication of the prioritized maintenance of the one or more home devices. Still further, instructions stored in home warranty management application 207 may facilitate the processor unit 202 performing functions such as allocating a portion of the home warranty premium to respective preventative maintenance categories, adjusting this allocation as additional home telematics data is collected, and/or determining a cause of failure. As further described herein, these functions may be performed utilizing the collected home telematics data and/or energy profiles, and may be repeated as additional home telematics data is collected over time.

In the present aspects, home warranty management application 207 may include any suitable combination of functions as discussed herein. For example, as shown in FIG. 2, home warranty management application 207 may include a data aggregation module 209, a home warranty pricing module 211, a preventative maintenance module 213, and a premium allocation module 215. These modules are for illustrative purposes, and represent examples of some of the functionality that may be performed by home warranty assessment engine 200. However, certain aspects include home warranty management application 207 including additional, less, or alternate actions, including those discussed elsewhere herein.

In one aspect, data aggregation module 209 may be a portion of memory unit 206 configured to store instructions, that when executed by processor unit 202, cause processor unit 202 to perform various acts in accordance with applicable embodiments as described herein. In the present aspects, instructions stored in data aggregation module 209 may facilitate processor unit 202 performing functions such as collecting home telematics data over various time periods and using the collected home telematics data to calculate one or more energy profiles. For example, instructions stored in data aggregation module 209 may facilitate home warranty assessment engine 200 receiving home telematics data during an initial (e.g., trial) time period prior to a customer purchasing a home warranty. Again, an energy profile may be calculated using the home telematics data for each individual home device for which home warranty coverage is sought (e.g., one or more of home devices 112a-112i) and/or the overall home (e.g., home 102). Because this energy profile may indicate various metrics related to each home device's energy usage, consumption, etc., the energy profile may indicate deviations or anomalies over a period of time to allow the overall present and likely future health of each home device to be ascertained.

To provide an illustrative example, the energy profile for water heater 112a, which may include an aggregation of home telematics data collected during a specific time period, may indicate a level of electrical current usage that exceeds the expected electrical current when the water heater 112a is not in use (e.g., during the evening hours). This may indicate an underlying issue with the water heater 112a, e.g. that it is incapable of maintaining the temperature of the hot water and will thus be subjected to excessive wear and tear over time.

To provide another illustrative example, the energy profile for HVAC system 112b may track the on and off cycles in accordance with the home's HVAC control system. For example, as a furnace turns on, transient electrical usage may be correlated to the furnace switching times. As another example, the steady state electrical usage by the furnace may be correlated to the times during which the furnace was operating. As yet another example, deviations in the electrical usage over time within a monitoring period (e.g., the trial period) may further indicate a slowly degrading component. Thus, if any of the aforementioned metrics (or other relevant metrics indicated by the energy profiles) are outside of an expected operating range, then the energy profile for HVAC system 112b may facilitate the identification of a more severe underlying issue, such as an issue with a blower motor, a heater, etc.

To provide yet another illustrative example, the energy profile for the washer 112f may indicate, in addition to or instead of the aforementioned electrical usage metrics described above, how often the washer is used. In other words, the energy profiles may include “high-level” information such as how often a particular home device is used and/or “low-level” diagnostic information regarding the actual state and/or operation of each home device. Although both types of information may be contained (or derived) from the energy profile of each home device, each type of information may reveal different metrics regarding the overall health of each home device. Continuing the example with respect to the washer 112f, the energy profile may indicate that, during the home telematics data monitoring period, that the washer 112f was used for a number of wash cycles that exceeds an ordinary range of use.

In other words, various metrics obtained via an analysis of each home device's energy profile may indicate an overall current health and/or a projection regarding the likelihood that each home device will need to be repaired or replaced over a future time period. Referring to the previous examples, the home warranty assessment engine 200 may utilize the energy profile data to calculate this overall likelihood for a specific future time period, which may advantageously be established as the term for home warranty coverage (e.g., 1 year, 2 years, etc.).

To do so, home warranty pricing module 211 may be a portion of memory unit 206 configured to store instructions, that when executed by processor unit 202, cause processor unit 202 to perform various acts in accordance with applicable embodiments as described herein. For example, aspects include instructions stored in home warranty pricing module 211 facilitating home warranty assessment engine 200 calculating the likelihood that each home device will need to be repaired or replaced over a future time period using each home device's energy profile, as discussed above and elsewhere herein.

In various aspects, the home warranty assessment engine 200 may calculate this likelihood based upon the home telematics data contained in the each home device's energy profile, the metrics obtained via this home telematics data, and/or the type of home device. For instance, the processor unit 202 may execute instructions stored in home warranty pricing module 211 to analyze the energy profile of each home device to identify specific operational states and/or issues based upon the normal operation, usage, and expected lifetime of similar devices and/or the historical usage of similar (or the same) home devices. In various aspects, any suitable number and/or type of metrics obtained via each home device's energy profile may be utilized to make these calculations.

For instance, continuing the example provided above with respect to the water heater 112a, the energy profile for the home water heater may be based upon a trial monitoring period of one week, during which home telematics data is collected and used to generate an energy profile. The home warranty assessment engine 200 may identify, via an analysis of the timeline of electrical usage by the water heater 112a during this time period, that the pattern and magnitude of electrical usage are most likely associated with a degrading electronic ignition system, resulting in the water heater 112a periodically attempting, and failing, to maintain the hot water at a certain temperature. Continuing this example, based upon these metrics, the home warranty assessment engine 200 may further conclude that in similar scenarios, the likelihood that this particular component will fail within the next 12 months is fairly high (e.g., greater than 75%).

In various aspects, this determination may be made, for example, by comparing specific metrics obtained via the energy profile (or changes in those metrics during the monitoring period) with similar respective reference metrics regarding the use of similar types of home devices, the expected ranges for those metrics (or ranges associated with the expected change over time) for similar types of home devices, etc. These reference metrics may be stored locally in the home warranty assessment engine 200 and/or accessed via communications with one or more backend components, for example. Thus, based upon such comparisons, the presence of specific types of metrics (or changes in those metrics) may allow the home warranty assessment engine 200 to assess the overall health of the water heater 112a at the end of the one week trial monitoring period, and to calculate a probability of the water heater 112a (or components thereof) failing within a projected, future time period.

This process may be repeated for each home device to be covered by the home warranty and, allowing the likelihood of each of the one or more home devices needing to be replaced or repaired within a future time period to be calculated. Certain aspects include the home warranty assessment engine 200 further calculating a level of risk of covering one or more of these home devices with a home warranty. Continuing the previous example with respect to the water heater 112a and assuming that the home warranty term will be one year, the processor unit 202 may execute instructions stored in home warranty pricing module 211 to ascertain the level of risk to the home warranty provider. To do so, it may be assumed that the water heater 112a will fail during the term of the home warranty if purchased, and that this failure will include replacement of the electronic ignition system. In this scenario, although the likelihood that a component of the water heater 112a will soon fail is relatively high, the cost of repairs (i.e., replacing the electronic ignition system) is assumed to be relatively low.

Therefore, the level of risk associated with the calculated likelihood of failure may be determined as a relatively low level of risk. In various aspects, the level of risk may be based upon any suitable number and/or type of factors, such as the anticipated repair costs in conjunction with the likelihood of the repair being required, for example. Thus, the level of risk may be calculated as a numeric scaled system (e.g., 1-10), a tiered level system (e.g., low, medium, high), a percentage (e.g., 0%=no risk; 100%=high risk), etc.

Continuing the previous example with respect to the HVAC system 112b, the deviations in the electrical usage over time during the monitoring period (as indicated by the energy profile) may likewise be analyzed. Based upon the magnitude, patterns, and/or metrics associated with the electrical usage of the HVAC system 112b as indicated by the energy profile, the home warranty assessment engine 200 may determine that the likelihood of a furnace blower motor failing in the near future is relatively high. Moreover, because the repair or replacement cost of this particular component is significant, the home warranty assessment engine 200 may further calculate the level of risk of covering the HVAC system 112b as a high level of risk.

Continuing the previous example with respect to the washer 112f, the magnitude, patterns, and/or metrics associated with the electrical usage of the washer 112f (as indicated by the energy profile) may also be analyzed. Based upon the patterns of electrical usage indicated by the energy profile, the home warranty assessment engine 200 may determine that, although the washer 112f is used more frequently than average, that the likelihood of the washer 112f needing to be repaired or replaced in the near future is still relatively low, assuming that no other anomalous metrics are identified. Thus, the home warranty assessment engine 200 may further calculate the level of risk of covering the washer 112f as relatively low.

In various aspects, the process of identifying the likelihood that each home device to be covered by the home warranty fill fail within a future time period may be calculated in any suitable manner, enabling the home warranty assessment engine 200 to calculate the level of risk of covering each home device with a home warranty. Additionally, once the level of risk is known for each home device to be covered by the home warranty, the processor unit 202 may execute instructions stored in home warranty pricing module 211 to calculate a home warranty premium based upon each home device's calculated level of risk.

This calculation may be performed in any suitable manner to correlate the home warranty premium to the overall risk of covering each of the home devices, thus mitigating the risk absorbed by the home warranty provider in doing so. For instance, the home warranty provider may apply any suitable actuarial analysis to identify an overall level of risk associated with covering each of the home devices via a home warranty for a term equivalent to the projected future time period discussed above, during which the likelihood of failure of each home device was determined (e.g., one year). To provide some illustrative examples, the home warranty assessment engine 200 may calculate this overall risk based upon an average risk of each of the home devices, by applying a weighted average to emphasize more expensive home devices, etc.

In one embodiment, once the home warranty premium is calculated, the home warranty assessment engine 200 may cause the home warranty premium to be transmitted (e.g., via communication unit 204) to the potential or current home warranty customer via any suitable transmission medium and to any suitable computing device. For example, the user 117, as shown in FIG. 1, may be a potential or current home warranty customer. In such a case, the home warranty assessment engine 200 may cause the home warranty premium to be transmitted to the mobile computing device 114, which is associated with the user 117, and to be displayed to the user 117 in this way.

The aforementioned examples regarding the calculation of a home warranty premium have been explained with reference to a trial monitoring period for home devices that are not yet covered by a home warranty. However, some aspects include the home warranty assessment engine 200 continuing to collect home telematics data over time once the home warranty is purchased, and using the additionally collected home telematics data to update existing energy profiles and/or to calculate new energy profiles. Thus, as these ongoing processes continue, the home warranty assessment engine 200 may analyze these updated and/or new energy profiles to provide additional advantages for the home warranty customer and/or provider.

For instance, the trial monitoring period described above was used to calculate a likelihood of whether the one or more home devices will need to be replaced or repaired within the term of the home warranty. Once the customer purchases the home warranty, the term of the home warranty may then function as another monitoring time period, allowing the home warranty assessment engine 200 to calculate a likelihood of whether the one or more home devices will need to be replaced or repaired within a time period that is further into the future or until the end of the term.

This future time period may include, for instance, a renewal term beyond the initial home warranty term, and thus the current term may allow the home warranty assessment engine 200 to calculate a level of risk for a future term, to calculate a premium for the additional warranty term, and to notify the customer of any updates to the premium as additional home telematics data is collected and analyzed. In this way, the home warranty assessment engine 200 advantageously allows the home warranty provider to, upon the home warranty being renewed, to further mitigate the home warranty provider's exposure to risk.

Again, upon a home warranty customer purchasing the home warranty, additional home telematics data may be collected during the home warranty term. This may allow the home warranty assessment engine 200 to calculate the likelihood of various covered home devices needed to be repaired or replaced, as discussed above with regards to the trial monitoring period. Additionally or alternatively, this likelihood, and the details associated with the likely failure or replacement, may be used to determine one or more recommendations to provide to the customer to avoid one or more home devices from requiring potentially complex and/or costly repairs.

To provide an illustrative example, if it is determined during the term of the home warranty that the electronic igniter of the water heater 112a will likely fail before the end of the term, this specific recommendation may be sent to the customer (e.g., via the mobile computing device 114). To provide another example, the energy profile for the HVAC system 112b may indicate during the home warranty period that the furnace is drawing, upon starting a heating cycle, an amount of transient current that exceeds what is to be expected by 15% and that, if this continues, the likelihood of the blower motor failing before the end of the term will be relatively high. Assuming that the higher transient current may be indicative of partially blocked vents or air intake ducts, the home warranty assessment engine 200 may recommend that the user schedule cleaning of the HVAC system 112b (e.g., via a transmitted notification to mobile computing device 114), and continue to monitor the home telematics data to determine if the HVAC system 112b returns to normal operation. In this way, the home warranty assessment engine 200 may continuously monitor the home telematics data for covered home devices, proactively suggest recommendations to prevent the failure of costly component, and potentially prevent a claim from being made, thus mitigating the home warranty provider's risk exposure.

Preventative maintenance module 213 may be a portion of memory unit 206 configured to store instructions, that when executed by processor unit 202, cause processor unit 202 to perform various acts in accordance with applicable embodiments as described herein. As discussed above, various recommendations may be determined based upon the analysis of home telematics data collected over time. Because some of these recommendations may be more important than others, some aspects may include the home warranty assessment engine 200 identifying a prioritization among the various recommendations, which may include preventative maintenance, and transmitting this information to the customer (e.g., via the mobile computing device 114).

For example, some aspects may include instructions stored in preventative maintenance module 213 facilitating home warranty assessment engine 200 prioritizing preventative maintenance for the various home devices covered by the home warranty (or the home itself). To do so, certain aspects include home warranty assessment engine 200 using any suitable combination of rules, logic, and/or specific factors. Using the previous examples with respect to the water heater 112a, the HVAC system 112b, and the washer 112f, it was noted above that the energy profile of the furnace may indicate that cleaning is required and, if this is not done, then the blower motor may soon fail. Because the cost of repairing or replacing a blower motor may be substantially greater than replacing the electronic ignition should it fail, the home warranty assessment engine 200 may prioritize scheduling the cleaning of the HVAC system 112b over the replacement of the electrical ignition for the water heater 112a.

Although the above prioritization was based upon potential cost of a repair or replacement should a home warranty claim be filed, certain aspects may include the home warranty assessment engine 200 prioritizing any suitable type of preventive maintenance based upon any suitable conditions. For instance, the prioritization may be based upon the likelihood of each covered home device failing, how soon each device is expected to fail, the level of risk of each device failing, the cost of repair or replacement, or any combination of these factors.

Moreover, certain aspects include the home warranty assessment engine 200 prioritizing other types of preventative maintenance that may not be directly based upon the home telematics data. For example, other types of preventative maintenance may be recommended that are generally suggested for the upkeep of a home, such as cleaning gutters to prevent water dams from building up, trimming trees to reduce the likelihood of damage to the home from falling branches, etc. Although these types of preventative maintenance may not directly correlate with the collected home telematics data, the home warranty assessment engine 200 may still identify the overall benefit of performing such maintenance in terms of mitigated risk, and prioritize the preventative maintenance for a home by taking these types of preventative maintenance into consideration when doing so.

Furthermore, aspects include instructions stored in preventative maintenance module 213 facilitating home warranty assessment engine 200 identifying the cause of failure of covered home devices by analyzing the energy profile of those devices. In some cases, the failure may be caused by the customer failing to act upon recommended preventative maintenance, or for other reasons. In any event, once the cause of failure is identified, the home warranty assessment engine 200 may, in some cases, use this information to further improve upon future recommendations and future prioritization of preventative maintenance. Identifying the cause of failure may also be particularly useful, for instance, when the customer is contractually obligated to act upon the home warranty provider's recommendations, as it may provide evidence of the customer's failure to do so.

In any event, regardless of the attempts to prevent the need to replace or repair a covered home device, ultimately the need to do so may occur. In such a case, certain aspects include the home warranty provider implementing a unique claim processing strategy that provides advantages over existing ones. In particular, aspects include the implementation of a concierge-based home warranty claim system. For example, if one of the home devices 112a-112i needs to be repaired or replaced, then user 117 (who is assumed to be the customer) may submit a claim to the home warranty provider via any suitable manner (e.g., via mobile computing device 114).

Once the home warranty provider receives the claim (e.g., via the home warranty assessment engine 200), the home warranty provider may contact a contractor and follow up with the contractor to determine that everything is completed. Typically, once a claim is received, the home warranty provider simply hands off the work to a contractor and has no further communication with either the customer or the contractor. Thus, the aspects described herein provide for an improved claim process whereby the home warranty provider takes a more active and involved role, coordinates the repairs with the contractor, and notifies the customer with updates and scheduling information. In doing so, accountability is placed upon the contractor to follow up directly with the company who will be issuing payment for services rendered, allowing the work to be completed with minimal or no intervention from the customer.

Again, various types of preventative maintenance may be recommended based upon the collected home telematics data (or other data sources), which may be prioritized using various factors. Although the preventative maintenance will save the home warranty provider and/or the customer money in the long term, the cost of performing such preventative maintenance is not trivial for the customer, and may not be covered by traditional home warranties. Thus, some aspects include the instructions stored in premium allocation module 215 facilitating home warranty assessment engine 200 allocating a portion of premium payments to an account, which may then be used to reimburse or otherwise fund a portion of (or all of) the costs to perform the recommended preventative maintenance.

For example, the home warranty provider may set a predetermined portion (e.g., 5%, 10%, 15%, etc.) of a premium payment (e.g., weekly, monthly, quarterly, etc.) aside in a virtual allowance account, which is then associated with the customer's account. In some aspects, the monetary preventative maintenance allocation may roll over if not used, and may also function as feedback to the home warranty provider regarding whether the customer is carrying out the recommended preventative maintenance. This allocation may be further divided into specific preventative maintenance categories or classifications, such as exterior maintenance (e.g., gutter cleaning, tree trimming, etc.), periodic inspections, professional cleaning, part replacement, upkeep, etc. In various aspects, the proportion of the premium payment and/or the amount allocated amongst the various categories may be changed over time as additional home telematics data is collected and the preventative maintenance prioritization is updated.

In this way, the customer may be incentivized to take an active role in performing the preventative maintenance, as doing so will incur only minimal (or zero) costs to be paid out of pocket by the customer. Like the other information discussed above, details associated with the allocation, adjustments to the allocated amount, the categorization of the allocated amount, the current balance, etc., may be communicated to the customer via a transmission from communication unit 204. This may be in the form of any suitable communication to any suitable computing device associated with the customer (e.g., mobile computing device 114). The details of these various notifications are further discussed below.

In various aspects, one or more portions of the following methods 300, 400, 500, and 600 (or the entire respective methods) may be implemented by any suitable device, and one or more portions of each respective method may be performed by more than one suitable device in combination with one another. For example, one or more portions of each respective method may be performed by home warranty assessment engine 200, as shown in FIG. 2. In one aspect, each respective method may be performed by any suitable combination of one or more processors, instructions, applications, programs, algorithms, routines, etc. For example, each respective method may be performed via processor unit 202 executing instructions stored in home warranty management application 207 in conjunction with data collected, received, and/or aggregated via home warranty assessment engine 200, such as home telematics data discussed herein, for example.

### Exemplary Method of Calculating a Home Warranty Premium Using Home Telematics Data

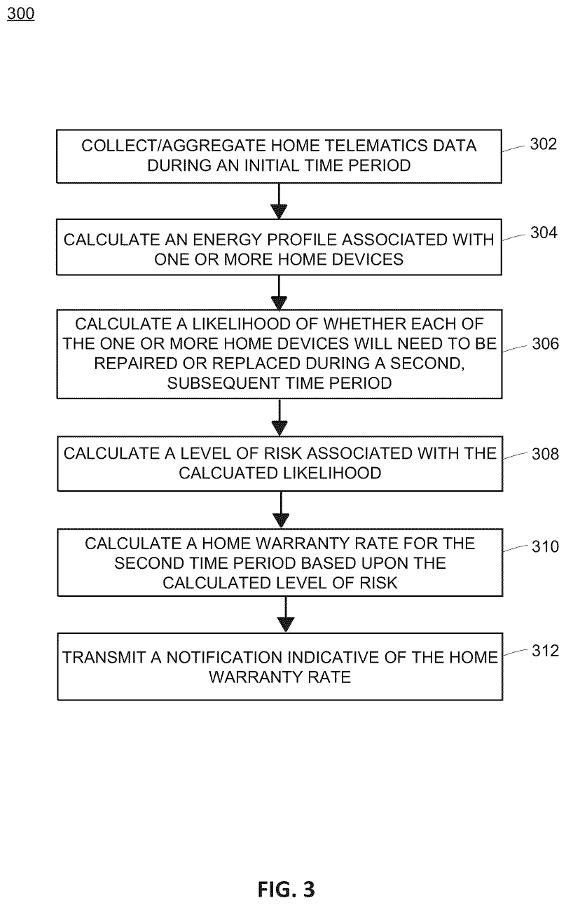

FIG. 3 illustrates an exemplary computer-implemented method 300 of using home telematics data to price home warranty premiums in accordance with one aspect of the present disclosure. Method 300 may start when one or more processors receive, collect, and/or aggregate home telematics data during an initial time period (block 302). In the present aspects, the home telematics data may be received from any suitable number and/or type of data sources. For example, the home telematics data may correspond to data collected via the EM device 110, one or more home devices 112a-112i, mobile computing device 114, one or more alarm systems, smart appliances, smart home controllers, etc., as shown and/or otherwise discussed with reference to FIGS. 1 and 2. The initial time period may correspond, for example, to a trial time period prior to the home warranty being purchased, thus providing the home warranty provider with information associated with the home devices to potentially be covered by a home warranty.

Method 300 may include one or more processors calculating an energy profile associated with one or more home devices (block 304). As discussed above, the energy profile may include an identification of various home devices that are to be covered (or already covered) by a home warranty. The energy profile may additionally include data indicative of the operation of each respective home device that is monitored during the initial time period and/or other diagnostic information associated with each respective home device. For instance, as discussed above, this energy profile may indicate details associated with the operation, electrical consumption, usage, etc., of each home device.

Method 300 may include one or more processors calculating a likelihood of whether each of the one or more home devices will need to be repaired or replaced during a second, subsequent time period (block 306). As discussed above, this likelihood may be calculated, for example, based upon an analysis of the energy profile of each home device. This may include, for instance, identifying specific signs of operational issues based upon the normal operation, usage, and expected lifetime of similar devices, and using this information to calculate a probability that each home device will fail within a projected time period (block 306).

Method 300 may include one or more processors calculating a level of risk associated with the calculated likelihood of whether each of the one or more home devices to potentially be covered by a home warranty will need to be repaired or replaced during a second, subsequent time period (block 308). The level of risk may be calculated, for instance, based upon any suitable number and/or type of factors, such as the anticipated repair costs in conjunction with the likelihood of the repair being required, as discussed above (block 308).

Method 300 may include one or more processors calculating a home warranty rate (i.e., a premium) for coverage of the home devices during the second, subsequent time period (block 310). This calculation may be performed, for example, using the calculated level of risk (block 310). The home warranty rate may be calculated, in various aspects, in any suitable manner to correlate the home warranty premium to the overall risk of covering each of the home devices for which home telematics data was collected (block 310).

Method 300 may include one or more processors transmitting a notification indicative of the home warranty rate (block 312). This notification may be transmitted, for example, as push notifications, email messages, text messages, etc. (block 312). These notifications may also include, for example, details associated with the home warranty premium and include a payment schedule, prompts to provide payment, accept home warranty terms, etc. (block 312). Method 300 may include additional, less, or alternative actions, including those discussed elsewhere herein.

### Exemplary Method of Determining Recommendations to Mitigate the Cost of Home Warranty Claims Using Home Telematics Data

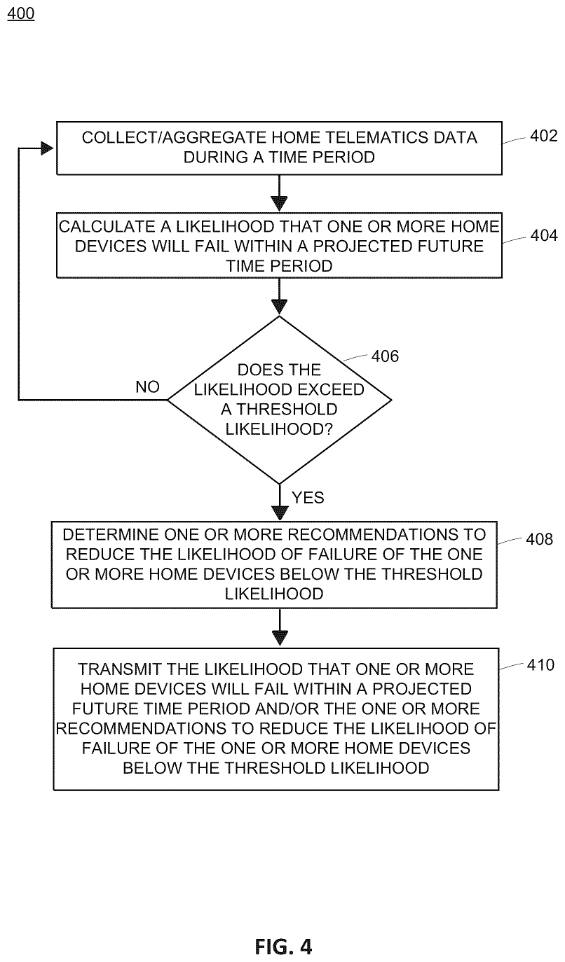

FIG. 4 illustrates an exemplary computer-implemented method 400 of using home telematics data to determine recommendations to reduce the likelihood of failure of one or more covered home devices in accordance with one aspect of the present disclosure. Method 400 may start when one or more processors receive, collect, and/or aggregate home telematics data during a time period (block 402). In the present aspects, the home telematics data may be received from any suitable number and/or type of data sources. For example, the home telematics data may correspond to data collected via the EM device 110, one or more home devices 112a-112i, mobile computing device 114, one or more alarm systems, smart appliances, smart home controllers, etc., as shown and/or otherwise discussed with reference to FIGS. 1 and 2. The time period may correspond, for example, to a time period occurring within a home warranty term. For example, this time period (block 402) may occur during (i.e., a portion of) the second, subsequent time period discussed above with reference to method 300 (block 306). In other words, for method 400, it may be assumed that a home warranty customer has purchased a home warranty in response to receiving the notification of the home warranty rate discussed above with reference to method 300 (block 312), and that home telematics data is continued to be collected once the term begins (block 402).

Method 400 may include one or more processors calculating a likelihood that each of the one or more home devices covered by a home warranty will need to be repaired or replaced during a projected future time period (block 404). As discussed above, this likelihood may be calculated, for example, based upon an analysis of the energy profile of each home device that is generated from the collected and aggregated home telematics data (block 404). This future time period may be a time period within the home warranty term (i.e., after the time period associated with the collection of the home telematics data but prior to the end of the term) (block 404).

Method 400 may include one or more processors determining whether the calculated likelihood (block 404) exceeds a threshold likelihood (block 406). This threshold likelihood may be any suitable value, such as 50%, 75%, etc. (block 406). If so, then method 400 may continue to determine one or more recommendations to reduce the likelihood of failure (block 408). Otherwise, method 400 may continue to collect and aggregate home telematics data (block 402).

Method 400 may include one or more processors determining one or more recommendations to reduce the likelihood of failure of the one or more home devices below the threshold value (block 408). This may include, for example, specific recommendations to address the issues identified from each home device's energy profile (block 408). These recommendations may include, for example, replacing a part, cleaning a home device or subset thereof, scheduling an inspection, performing any suitable preventative maintenance, etc. (block 408)

Method 400 may include one or more processors transmitting (block 410) the likelihood that the one or more home devices will fail within the projected time period (block 404) and/or the one or more recommendations (block 408). These recommendations may be transmitted, for example, to a suitable computing device to notify the home warranty customer accordingly. These recommendations may be transmitted, for example, as push notifications, email messages, text messages, etc. (block 410). Method 400 may include additional, less, or alternative actions, including those discussed elsewhere herein.

### Exemplary Method of Prioritizing Recommendations for Preventative Maintenance Using Home Telematics Data

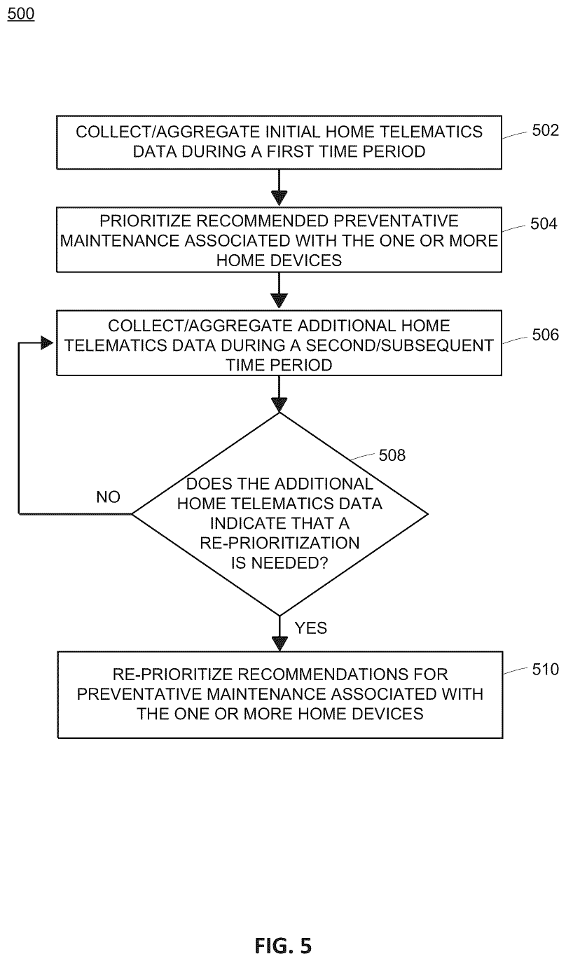

FIG. 5 illustrates an exemplary computer-implemented method 500 of using home telematics data to prioritize recommendations for preventative maintenance in accordance with one aspect of the present disclosure.

Method 500 may start when one or more processors receive, collect, and/or aggregate home telematics data during a first time period (block 502). Again, the home telematics data may be received from any suitable number and/or type of data sources. The first time period may correspond, for example, to a time period occurring within a home warranty term. For example, this first time period (block 502) may occur during (i.e., a portion of) the second, subsequent time period discussed above with reference to method 300 (block 306). In other words, for method 500, it may be assumed that a home warranty customer has purchased a home warranty in response to receiving the notification of the home warranty rate discussed above with reference to method 300 (block 312), and that home telematics data is continued to be collected once the term begins (block 502).

Method 500 may include one or more processors prioritizing recommended preventative maintenance associated with the one or more home devices (block 504). As discussed above, aspects include the prioritization being performed based upon any suitable conditions, such as the likelihood of each covered home device failing, how soon each device is expected to fail, the level of risk of each device failing, the cost of repair or replacement, etc., or any combination of these factors (block 504). For example, via an analysis of a first set of energy profiles that are based upon home telematics data collected over the first time period (block 502), it may be determined that water heater 112a will soon require a new electronic igniter. Moreover, it may further be determined that the HVAC system 112b is showing early signs of poor operating efficiency (e.g., 10% below normal) and will need to be cleaned soon.

Thus, because the HVAC system efficiency is operating a small amount below

expectations, the current prioritization may include (1) replace electrical igniter on water heater 112a, and (2) schedule cleaning of HVAC system 112b (block 504). Of course, this prioritization may also be transmitted to a suitable computing device to notify the home warranty customer of these recommendations and their prioritization.

Method 500 may include one or more processors collecting and aggregating home telematics data during a second, subsequent time period (block 506). The second time period may correspond, for example, to a time period occurring after the first time period (block 502) but still within the home warranty term. For example, this second time period (block 506) may occur after the first time period such that additional telematics data is continued to be collected after the initial preventative maintenance prioritization is determined (block 506).

Method 500 may include one or more processors determining whether the additional home telematics data collected during the second time period (block 506) indicates that a re-prioritization of preventative maintenance is needed (block 508). This may include, for example, analyzing the energy profiles (or the home telematics data included in the energy profiles) associated with the second time period and/or comparing the energy profiles (or the home telematics data included in the energy profiles) of the first and the second time periods to one another (block 508). In the event that the most recently collected home telematics data (i.e., the home telematics data collected during the second time period (block 506)) indicates deviations or anomalies alone, or when compared to the various metrics associated with the first time period, then method 500 may include determining that the preventative maintenance needs to be reprioritized (block 510). Otherwise, method 500 may continue to collect and aggregate home telematics data during the subsequent time period (block 506).

For example, via an analysis of a first set of energy profiles (i.e., based upon home telematics data collected over the first time period) (block 502), a determined priority for preventative maintenance was (1) replace electrical igniter on water heater 112a, and (2) schedule cleaning of HVAC system 112b. However, an analysis (block 508) of a second set of energy profiles (i.e., based upon home telematics data collected over the second time period (block 506)), may reveal that the HVAC system 112b is decreasing in efficiency at a faster rate that was initially expected, and is now operating at 25% below the expected efficiency (block 508). Because this may be an indication of a more severe and immediate issue with the HVAC system 112b, the method 500 may include re-prioritizing the preventative maintenance recommendations to switch the previous prioritization (block 510). Again, this re-prioritization may also be transmitted to a suitable computing device to notify the home warranty customer accordingly. Method 500 may include additional, less, or alternative actions, including those discussed elsewhere herein.

### Exemplary Method of Allocating a Portion of Home Warranty Premiums for Preventative Maintenance

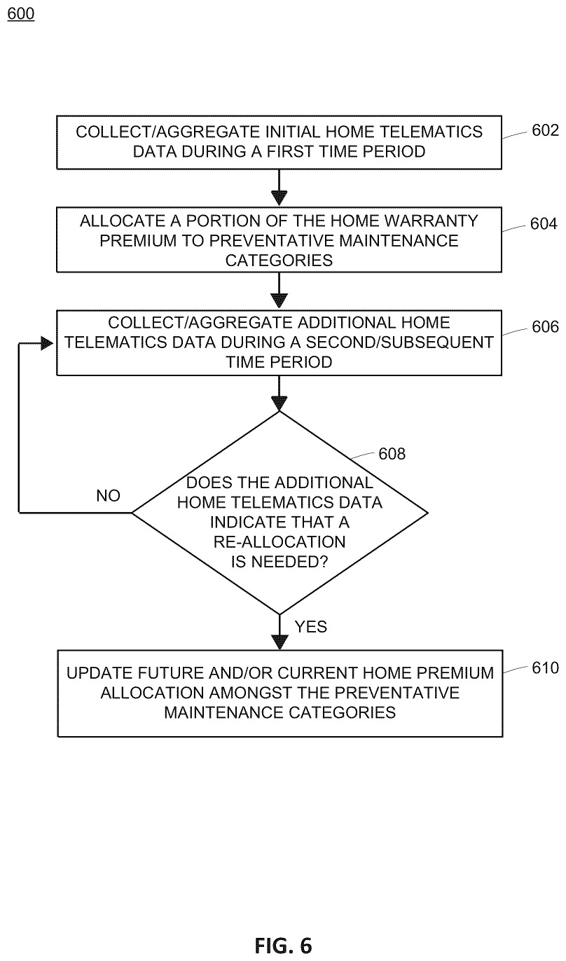

FIG. 6 illustrates an exemplary computer-implemented method 600 of using home telematics data to allocate a portion of a home warranty premium into preventative maintenance categories in accordance with one aspect of the present disclosure.

Method 600 may start when one or more processors receive, collect, and/or aggregate home telematics data during a first time period (block 602). Again, the home telematics data may be received from any suitable number and/or type of data sources. The first time period may correspond, for example, to a time period occurring within a home warranty term. For example, this first time period (block 602) may occur during (i.e., a portion of) the second, subsequent time period discussed above with reference to method 300 (block 306). In other words, for method 600, it may be assumed that a home warranty customer has purchased a home warranty in response to receiving the notification of the home warranty rate discussed above with reference to method 300 (block 312), and that home telematics data is continued to be collected once the term begins (block 602).

Method 600 may include one or more processors allocating a portion of the calculated home warranty premium to an account associated with one or more preventative maintenance categories or classifications (block 604). As discussed above, this portion of the calculated home warranty premium may be a predetermined portion, for example, of the calculated premium payment, which may be set aside in a virtual account and associated with the customer (block 604).

Method 600 may include one or more processors collecting and aggregating home telematics data during a second, subsequent time period (block 606). The second time period may correspond, for example, to a time period occurring after the first time period (block 602) but still within the home warranty term. For example, this second time period (block 606) may occur after the first time period such that additional telematics data is continued to be collected after the initial prioritization for preventative maintained is determined (block 606).

Method 600 may include one or more processors determining whether the additional home telematics data collected during the second time period (block 606) indicates that a re-allocation of the home warranty premium to various categories of preventative maintenance is needed (block 608). This may include, for example, analyzing the energy profile (or the home telematics data included in the energy profile) associated with the second time period and/or comparing the energy profiles (or the home telematics data included in the energy profiles) of the first and the second time periods to one another (block 608). In the event that the most recent collected home telematics data (i.e., the home telematics data collected during the second time period) indicates deviations or anomalies alone, or when compared to the various metrics associated with the first time period, then method 600 may include determining that the preventative maintenance allocation needs to be re-allocated (block 610). Otherwise, method 600 may continue to collect and aggregate home telematics data during a subsequent time period (block 606).

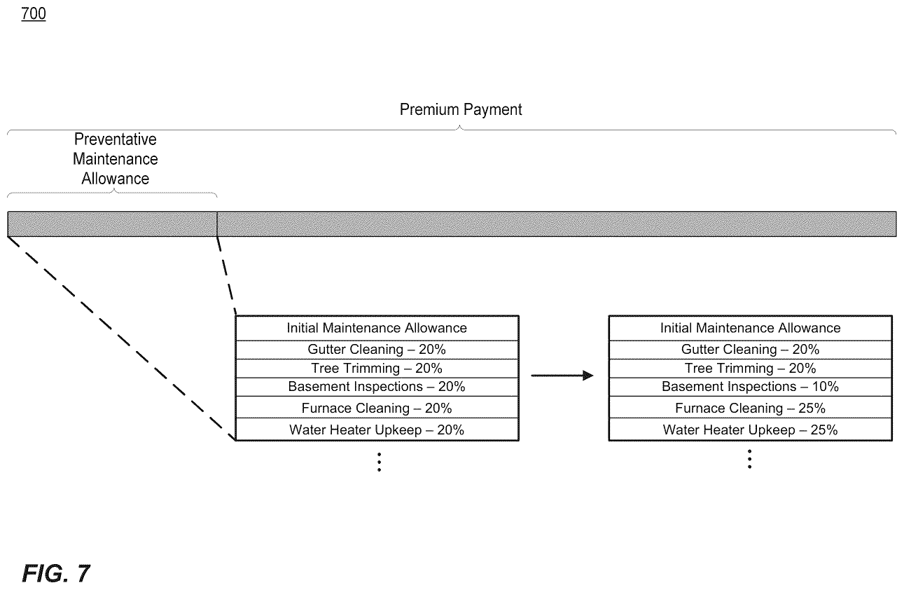

An illustrative example of this allocation (block 604) and re-allocation (block 610) may be provided with reference to FIG. 7, which illustrates an exemplary home warranty premium allocation 700 showing example preventative maintenance categories in accordance with an exemplary aspect of the present disclosure. As shown in FIG. 7, an initial allocation may result in a portion of the premium payment being equally divided amongst five different preventative maintenance categories: gutter cleaning (20%), tree trimming (20%), basement inspections (20%), furnace cleaning (20%), and water heater upkeep (20%). In this example, it is assumed that the first set of energy profiles (i.e., based upon home telematics data collected over the first time period) (block 602), do not indicate any potential likelihood that the water heater 112a and the HVAC system 112b need to be repaired or replaced in the near future.

However, an analysis of a second set of energy profiles (i.e., based upon home telematics data collected over the second time period) (block 606), may determine that the water heater 112a will require a replacement electric igniter, and that the HVAC system 112b is operating at an efficiency that is 20% below expectations (block 608). Thus, the method 600 may include re-allocating the preventative maintenance allowance to increase the allocation towards the furnace cleaning (25%) and the water heater upkeep (25%), while decreasing the amount that is allocated towards basement inspections (10%) (block 610). Again, this reallocation may also be transmitted to a suitable computing device to notify the home warranty customer. Method 600 may include additional, less, or alternative actions, including those discussed elsewhere herein.

### Exemplary Application Screen Showing Notifications in Accordance with a Home Warranty

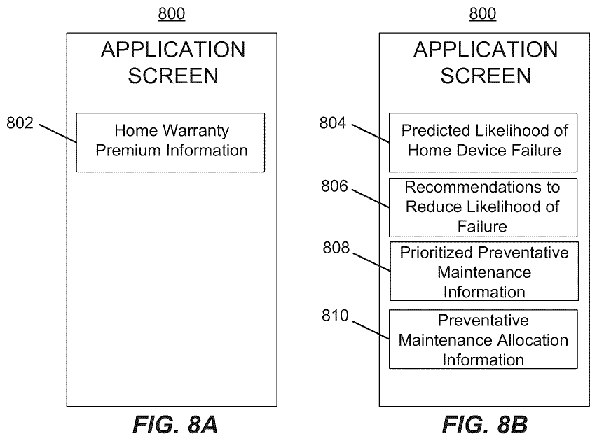

FIGS. 8A-8B illustrate an exemplary mobile computing device application screen 800 in accordance with one aspect of the present disclosure. In various aspects, application screen 800 may be displayed on a mobile computing device, such as mobile computing device 114, for example, as shown in FIG. 1.

In some aspects, application screens 800 may be displayed upon a user installing a suitable application, navigating to a webpage, etc., that may be associated with the home warranty provider. Additionally or alternatively, the information presented on the application screen 800 may be a result of notifications received via the home warranty assessment engine 200, or other suitable device associated with the home warranty provider.

For instance, FIG. 8A shows an application screen 800 that includes home warranty premium information 802, which may be an initial home warranty premium that is transmitted to the customer, a renewed home warranty premium, etc. To provide an example, the home warranty premium information 802 may include pricing information that is displayed upon the mobile computing device 114 receiving the transmitted notification indicative of the home warranty rate, as discussed with respect to method 300 and elsewhere herein.

To provide another example, FIG. 8B shows an application screen 800 that includes a predicted likelihood of home device failure 804, and recommendations to reduce the likelihood of failure 806. This information may be displayed, for example, upon the mobile computing device 114 receiving the transmitted notification indicative of the likelihood that the one or more home devices will fail within the projected time period and/or the one or more recommendations, as discussed with respect to method 400 and elsewhere herein.

To provide yet another example, FIG. 8B shows an application screen 800 that also includes prioritized preventative maintenance information 808. This may be displayed, for example, upon the mobile computing device 114 receiving the transmitted notification indicative of the prioritized preventative maintenance recommendations and/or the re-prioritized preventative maintenance recommendations, as discussed with respect to method 500 and elsewhere herein.

To provide a further example, FIG. 8B shows an application screen 800 that also includes preventative maintenance allocation information 810. This may be displayed, for example, upon the mobile computing device 114 receiving the transmitted notification indicative of the currant and/or updated allocation of the home warranty premium amongst the various preventative maintenance categories, as discussed with respect to method 600 and elsewhere herein.

The application screen 800 shown in FIGS. 8A-B indicates that different types of information are concurrently presented on a mobile computing device. However, some aspects may include the mobile computing device displaying any suitable number and/or type information in response to the particular notifications that are received from the home warranty assessment engine (or other suitable device) at any time.

### Exemplary Methods of Calculating Information Associated with a Home Warranty Using Home Telematics Data

In one aspect, a computer-implemented method of calculating and transmitting a home warranty premium based upon home telematics data may be provided. The method may include: (1) collecting, via one or more processors, initial home telematics data over a first time period, the initial home telematics data being indicative of electricity consumption of one or more home devices during the first time period that are to be covered by a home warranty; (2) calculating, via the one or more processors, an energy profile associated with the one or more home devices based upon the initial home telematics data collected during the first time period; (3) calculating, via the one or more processors, a likelihood of whether each of the one or more home devices will need to be replaced or repaired within a second time period in accordance with the energy profile; (4) calculating, via the one or more processors, a level of risk associated with the calculated likelihood of whether each of the one or more home devices will need to be replaced or repaired within the second time period; (5) calculating, via the one or more processors, a home warranty rate for the home warranty associated with the calculated level of risk; and/or (6) transmitting, via the one or more processors, a notification indicative of the home warranty rate. The method may include additional, less, or alternate actions, including those discussed elsewhere herein.

In one aspect, the second time period may be subsequent to the first time period and correspond to a term for the home warranty. In another aspect, the home telematics data may be at least partially generated by an Electricity Monitoring (EM) device that detects the electricity flowing to each of the one or more home devices as the one or more home devices are powered by the home's electrical system.

In various aspects, additional home telematics data may be continued to be collected (e.g., over the second time period or other, future time periods) and used for various purposes. For instance, a likelihood that one of the one or more home devices will fail based upon the additional home telematics data may be calculated, and the method may include transmitting one or more recommendations to a user to reduce the likelihood of failure of the one of the one or more home devices. Moreover, the additional collected home telematics data may also be used to determine, for example, a cause of failure based upon an analysis of the collected additional home telematics data when one of the one or more home devices need to be replaced or repaired.

Furthermore, the method may include prioritizing preventative maintenance associated with each of the one or more home devices based upon the additional collected home telematics data, and transmitting an indication of the prioritized maintenance of the one or more home devices to one or more users.

Additionally or alternatively, the method may include allocating a portion of the home warranty rate to respective preventative maintenance categories at the start of the second time period, and/or adjusting this allocation based upon the additional home telematics data that is collected over the second time period.

Still further, the method may include, at the end of the second time period, (1) calculating an updated energy profile associated with the one or more home devices based upon the additional home telematics data; (2) calculating a likelihood of whether each of the one or more home devices will need to be replaced or repaired within a third time period in accordance with the updated energy profile; (3) calculating a level of risk associated with the calculated likelihood of whether each of the one or more home devices will need to be replaced or repaired within the third time period; and/or (4) calculating an updated home warranty rate associated with the calculated level of risk. In one aspect, the third time period may be subsequent to the second time period, and/or correspond to a renewed term for the home warranty. The method may include additional, less, or alternative actions, including those discussed elsewhere herein.

In another aspect, a computer-implemented method may include (1) collecting, via one or more processors, initial home telematics data, the initial home telematics data being indicative of electricity consumption of one or more home devices that are to be covered by a home warranty; (2) calculating, via the one or more processors, an energy profile associated with the one or more home devices based upon the initial home telematics data collected; (3) calculating, via the one or more processors, a likelihood of whether each of the one or more home devices will need to be replaced or repaired within a given time period, or by or before a specific date in accordance with the energy profile; (4) calculating, via the one or more processors, a level of risk associated with the calculated likelihood of whether each of the one or more home devices will need to be replaced or repaired within the given time period, or by or before a specific date; (5) calculating, via the one or more processors, a home warranty rate for the home warranty associated with the calculated level of risk; and/or (6) transmitting, via the one or more processors, a notification indicative of the home warranty rate, wherein the given time period corresponds to, or specific date is within, a term for the home warranty. The method may include additional, less, or alternate actions, including those discussed elsewhere herein.

In another aspect, a computer-implemented method for mitigating or preventing risk, and/or identifying failing electronic devices may be provided. The method may include (1) collecting or receiving, via one or more processors or associated transceivers, electricity consumption or usage data for electronic devices or appliances within a home (such as via wireless communication or data transmission over one or more radio links or communication channels); (2) determining or estimating, via the one or more processors, a useful or effective remaining life for each electronic device or appliance within the home; (3) based upon the useful or effective remaining life for each electronic device or appliance within the home, via the one or more processors, generating (or dynamically adjusting or updating) a home warranty for the home or determining a home warranty rate or premium for the home; and/or (4) generating and transmitting (such as via wireless communication or data transmission over one or more radio links or communication channels), via the one or more processors and/or transceivers, a home warranty quote (or a dynamically updated home warranty premium or rate) for the home to the mobile device of the home owner or occupant to facilitate more appropriately matching home warranty cost and risk. The electricity consumption or usage data may be generated or collected by an electricity monitoring (EM) device associated with the home or a breaker box of the home that is capable of identifying an electronic fingerprint of each electronic device and/or appliance operating within the home, and/or correlating electricity usage for the each electronic device and/or appliance using its electronic fingerprint. The method may include additional, less, or alternate actions, including those discussed elsewhere herein.

In another aspect, a computer-implemented method for mitigating or preventing risk may be provided. The method may include (1) collecting or receiving, via one or more processors or associated transceivers, electricity consumption or usage data for electronic devices or appliances within a home (such as via wireless communication or data transmission over one or more radio links or communication channels); (2) determining or estimating, via the one or more processors, that one or more of the electronic devices and/or appliances is failing and/or in need of maintenance: (3) based upon the one or more of the electronic devices and/or appliances failing and/or in need of maintenance useful, via the one or more processors, dynamically updating or adjusting a home warranty for the home or a home warranty rate or premium for the home; and/or (4) generating and transmitting (such as via wireless communication or data transmission over one or more radio links or communication channels), via the one or more processors and/or transceivers, an updated or adjusted home warranty quote, rate, or premium for the home to the mobile device of the home owner or occupant to facilitate more appropriately matching home warranty cost and risk. The method may include additional, less, or alternate actions, including those discussed elsewhere herein.

In another aspect, a computer-implemented method for mitigating or preventing risk may be provided. The method may include (1) collecting or receiving, via one or more processors or associated transceivers, electricity consumption or usage data for electronic devices or appliances within a home (such as via wireless communication or data transmission over one or more radio links or communication channels); (2) determining or estimating, via the one or more processors, a likelihood that one or more of the electronic devices and/or appliances will fail within a home warranty period; (3) based upon the likelihood that one or more of the electronic devices and/or appliances will fail within the home warranty period, via the one or more processors, dynamically updating or adjusting a home warranty for the home or a home warranty rate or premium for the home; and/or (4) generating and transmitting (such as via wireless communication or data transmission over one or more radio links or communication channels), via the one or more processors and/or transceivers, an updated or adjusted home warranty quote, rate, or premium for the home to the mobile device of the home owner or occupant to facilitate more appropriately matching home warranty cost and risk. The method may include additional, less, or alternate actions, including those discussed elsewhere herein.

In another aspect, a computer-implemented method for mitigating or preventing risk may be provided. The method may include (1) collecting or receiving, via one or more processors or associated transceivers, electricity consumption or usage data for electronic devices or appliances within a home (such as via wireless communication or data transmission over one or more radio links or communication channels); (2) determining or estimating, via the one or more processors, a likelihood that maintenance is needed to prolong the useful or effective life of one or more of the electronic devices and/or appliances covered by a home warranty; (3) based upon the likelihood that maintenance is need to prolong the useful or effective life of one or more of the electronic devices and/or appliances, via the one or more processors, dynamically updating or adjusting a home warranty for the home or a home warranty rate or premium for the home and/or determining a recommended maintenance item; and/or (4) generating and transmitting (such as via wireless communication or data transmission over one or more radio links or communication channels), via the one or more processors and/or transceivers, the recommended maintenance item and/or an updated or adjusted home warranty quote, rate, or premium for the home to the mobile device of the home owner or occupant to facilitate more appropriately matching home warranty cost and risk. The method may include additional, less, or alternate actions, including those discussed elsewhere herein.

In yet another aspect, a computer-implemented method of determining recommendations associated with a home warranty may be provided. The method may include: (1) collecting, via one or more processors, home telematics data over an initial time period, the home telematics data being indicative of electricity consumption of one or more home devices during the initial time period that are to be covered by a home warranty; (2) calculating, via the one or more processors, a likelihood of whether each of the one or more home devices will fail within a projected future time period based upon the collected home telematics data, the projected future time period occurring subsequent to the initial time period; (3) determining, via the one or more processors, whether each respective calculated likelihood exceeds a threshold likelihood; (4) for each calculated likelihood that exceeds the threshold likelihood, determining, via the one or more processors, one or more recommendations to reduce each calculated likelihood below the threshold likelihood; and/or (5) transmitting, via the one or more processors, the one or more recommendations to a computing device associated with a customer having purchased the home warranty. In at least some aspects, the home telematics data may be at least partially generated by an Electricity Monitoring (EM) device that detects the electricity flowing to each of the one or more home devices as the one or more home devices are powered by a home's electrical system. The method may include additional, less, or alternate actions, including those discussed elsewhere herein.

Additionally or alternatively, for each calculated likelihood that exceeds the threshold likelihood, the calculated likelihood may be transmitted to the computing device. In the event that none of the respective calculated likelihoods exceed the threshold likelihood, the method may include (1) collecting, via the one or more processors, additional home telematics data over a subsequent time period, the additional home telematics data being indicative of electricity consumption of the one or more home devices during the subsequent time period; (2) recalculating, via the one or more processors, the likelihood of whether each of the one or more home devices will fail within the projected future time period based upon the additional home telematics data: (3) determining, via the one or more processors, whether each respective recalculated likelihood exceeds the threshold likelihood; (4) for each re-calculated likelihood that exceeds the threshold likelihood, determining, via the one or more processors, one or more recommendations to reduce each re-calculated likelihood below the threshold likelihood; and/or (5) transmitting, via the one or more processors, the one or more recommendations to the computing device. In at least some embodiments, the subsequent time period may occur after the initial time period and prior to the end of the projected future time period

Furthermore, aspects include the one or more recommendations being determined and transmitted only when at least one of the one or more home devices has a respective calculated likelihood of failure within the projected future time period that exceeds the threshold likelihood. These recommendations may include, for instance, replacing a part associated with the one or more home devices, cleaning the one or more home devices, scheduling an inspection of the one or more home devices, and/or performing preventative maintenance of the one or more home devices.

### Additional Exemplary Home Warranty Assessment Engines

In another aspect, a home warranty assessment engine may be provided. The home warranty assessment engine may include (1) a communication unit configured to receive initial home telematics data over a first time period, the initial home telematics data being indicative of electricity consumption of one or more home devices during the first time period that are to be covered by a home warranty; and/or (2) a processor unit configured to: (a) calculate, an energy profile associated with the one or more home devices based upon the initial home telematics data receives during the first time period; (b) calculate a likelihood of whether each of the one or more home devices will need to be replaced or repaired within a second time period in accordance with the energy profile; (c) calculate a level of risk associated with the calculated likelihood of whether each of the one or more home devices will need to be replaced or repaired within the second time period; (d) calculate a home warranty rate for the home warranty associated with the calculated level of risk; and/or (e) transmit a notification indicative of the home warranty rate. The home warranty assessment engine may include additional, less, or alternate components, including those discussed elsewhere herein.

In one aspect, the second time period may be subsequent to the first time period and correspond to a term for the home warranty. In another aspect, the home telematics data may be at least partially generated by an Electricity Monitoring (EM) device that detects the electricity flowing to each of the one or more home devices as the one or more home devices are powered by the home's electrical system.

In various aspects, the home warranty assessment engine may collect additional home telematics data (e.g., over the second time period or other, future time periods) and use the additional home telematics data for various purposes. For instance, the home warranty assessment engine may calculate the likelihood that one of the one or more home devices will fail based upon the additional home telematics data, and/or transmit one or more recommendations to reduce the likelihood of failure of the one of the one or more home devices to a user. Moreover, the home warranty assessment engine may use the additional collected home telematics data to determine, for example, a cause of failure when one of the one or more home devices need to be replaced or repaired.

Furthermore, the home warranty assessment engine may prioritize preventative maintenance associated with each of the one or more home devices based upon the additional collected home telematics data, and transmit an indication of the prioritized maintenance of the one or more home devices.

Additionally or alternatively, the home warranty assessment engine may allocate a portion of the home warranty rate to respective preventative maintenance categories at the start of the second time period, and/or adjust this allocation based upon the additional home telematics data that is collected over the second time period.

Still further, the home warranty assessment engine may, at the end of the second time period, (1) calculate an updated energy profile associated with the one or more home devices based upon the additional home telematics data; (2) calculate a likelihood of whether each of the one or more home devices will need to be replaced or repaired within a third time period in accordance with the updated energy profile; (3) calculate a level of risk associated with the calculated likelihood of whether each of the one or more home devices will need to be replaced or repaired within the third time period; and/or (4) calculate an updated home warranty rate associated with the calculated level of risk. In one aspect, the third time period may be subsequent to the second time period, and correspond to a renewed term for the home warranty. The home warranty assessment engine may include additional, less, or alternate functionality, including that discussed elsewhere herein.

In yet another aspect, a home warranty assessment engine may be provided. The home warranty assessment engine may include (1) a communication unit configured to collect home telematics data over an initial time period, the home telematics data being indicative of electricity consumption of one or more home devices during the initial time period that are to be covered by a home warranty; and/or (2) a processor unit configured to: (a) calculate a likelihood of whether each of the one or more home devices will fail within a projected future time period based upon the collected home telematics data, the projected future time period occurring subsequent to the initial time period; (b) determine whether each respective calculated likelihood exceeds a threshold likelihood; and/or (c) for each calculated likelihood that exceeds the threshold likelihood, determine one or more recommendations to reduce each calculated likelihood below the threshold likelihood. Additionally or alternatively, the communication unit may be configured to transmit the one or more recommendations to a computing device associated with a customer having purchased the home warranty. In at least some aspects, the home telematics data may be at least partially generated by an Electricity Monitoring (EM) device that detects the electricity flowing to each of the one or more home devices as the one or more home devices are powered by a home's electrical system. The home warranty assessment engine may include additional, less, or alternate components, including those discussed elsewhere herein.

Additionally or alternatively, for each calculated likelihood that exceeds the threshold likelihood, the communication unit may be configured to transmit the calculated likelihood to the computing device. In the event that none of the respective calculated likelihoods exceed the threshold likelihood, the communication unit may be configured to collect additional home telematics data over a subsequent time period, the additional home telematics data being indicative of electricity consumption of the one or more home devices during the subsequent time period. Additionally or alternatively, the processor may be further configured to (1) recalculate the likelihood of whether each of the one or more home devices will fail within the projected future time period based upon the additional home telematics data; (2) determine whether each respective re-calculated likelihood exceeds the threshold likelihood; and/or (3) for each re-calculated likelihood that exceeds the threshold likelihood, determine one or more recommendations to reduce each re-calculated likelihood below the threshold likelihood. In such a case, the communication unit may be further configured to transmit the one or more recommendations to the computing device. In at least some embodiments, the subsequent time period may occur after the initial time period and prior to the end of the projected future time period.

Furthermore, aspects include the one or more recommendations being determined and transmitted only when at least one of the one or more home devices has a respective calculated likelihood of failure within the projected future time period that exceeds the threshold likelihood. Again, these recommendations may include, for instance, replacing a part associated with the one or more home devices, cleaning the one or more home devices, scheduling an inspection of the one or more home devices, and/or performing preventative maintenance of the one or more home devices.

### Exemplary Non-transitory Computer Readable Media

In yet another aspect, a non-transitory computer readable media may be described having instructions stored thereon that, when executed by a processor, cause the processor to: (1) receive initial home telematics data over a first time period, the initial home telematics data being indicative of electricity consumption of one or more home devices during the first time period that are to be covered by a home warranty; (2) calculate an energy profile associated with the one or more home devices based upon the initial home telematics data received during the first time period; (3) calculate a likelihood of whether each of the one or more home devices will need to be replaced or repaired within a second time period in accordance with the energy profile; (4) calculate a level of risk associated with the calculated likelihood of whether each of the one or more home devices will need to be replaced or repaired within the second time period; (5) calculate a home warranty rate for the home warranty associated with the calculated level of risk; and/or (6) transmit a notification indicative of the home warranty rate. The home warranty assessment engine may include additional, less, or alternate components, including those discussed elsewhere herein.

In one aspect, the second time period may be subsequent to the first time period and correspond to a term for the home warranty. In another aspect, the home telematics data may be at least partially generated by an Electricity Monitoring (EM) device that detects the electricity flowing to each of the one or more home devices as the one or more home devices are powered by the home's electrical system.

In various aspects, the instructions, when executed by one or more processors, may further cause the one or more processors to collect additional home telematics data (e.g., over the second time period or other, future time periods) and use the additional home telematics data for various purposes. For instance, the one or more processors may calculate the likelihood that one of the one or more home devices will fail based upon the additional home telematics data, and transmit one or more recommendations to reduce the likelihood of failure of the one of the one or more home devices to a user. Moreover, the one or more processors may use the additional collected home telematics data to determine, for example, a cause of failure when one of the one or more home devices need to be replaced or repaired.

Furthermore, the instructions, when executed by one or more processors, may further cause the one or more processors to prioritize preventative maintenance associated with each of the one or more home devices based upon the additional collected home telematics data, and transmit an indication of the prioritized maintenance of the one or more home devices.

Additionally or alternatively, the instructions, when executed by one or more processors, may further cause the one or more processors to allocate a portion of the home warranty rate to respective preventative maintenance categories at the start of the second time period, and adjust this allocation based upon the additional home telematics data that is collected over the second time period.

Still further, the instructions, when executed by one or more processors, may further cause the one or more processors to, at the end of the second time period, (1) calculate an updated energy profile associated with the one or more home devices based upon the additional home telematics data: (2) calculate a likelihood of whether each of the one or more home devices will need to be replaced or repaired within a third time period in accordance with the updated energy profile: (3) calculate a level of risk associated with the calculated likelihood of whether each of the one or more home devices will need to be replaced or repaired within the third time period; and/or (4) calculate an updated home warranty rate associated with the calculated level of risk. In one aspect, the third time period may be subsequent to the second time period, and correspond to a renewed term for the home warranty. The instructions may direct additional, less, or alternate functionality, including that discussed elsewhere herein.

In yet another aspect, a non-transitory computer readable media may be described having instructions stored thereon that, when executed by one or more processors, cause the one or more processors to: (1) collect home telematics data over an initial time period, the home telematics data being indicative of electricity consumption of one or more home devices during the initial time period that are to be covered by a home warranty; (2) calculate a likelihood of whether each of the one or more home devices will fail within a projected future time period based upon the collected home telematics data, the projected future time period occurring subsequent to the initial time period; (3) determine whether each respective calculated likelihood exceeds a threshold likelihood; (4) for each calculated likelihood that exceeds the threshold likelihood, determine one or more recommendations to reduce each calculated likelihood below the threshold likelihood; and/or (5) transmit the one or more recommendations to a computing device associated with a customer having purchased the home warranty. In at least some aspects, the home telematics data may be at least partially generated by an Electricity Monitoring (EM) device that detects the electricity flowing to each of the one or more home devices as the one or more home devices are powered by a home's electrical system. The non-transitory computer readable media may include additional, less, or alternate instructions, including those discussed elsewhere herein.

Additionally or alternatively, the instructions, when executed by the one or more processors, may cause the one or more processors to transmit each calculated likelihood that exceeds the threshold likelihood to the computing device. In the event that none of the respective calculated likelihoods exceed the threshold likelihood, the instructions may cause the one or more processors to (1) collect additional home telematics data over a subsequent time period, the additional home telematics data being indicative of electricity consumption of the one or more home devices during the subsequent time period; (2) re-calculate the likelihood of whether each of the one or more home devices will fail within the projected future time period based upon the additional home telematics data; (3) determine whether each respective recalculated likelihood exceeds the threshold likelihood; (4) for each re-calculated likelihood that exceeds the threshold likelihood, determine one or more recommendations to reduce each recalculated likelihood below the threshold likelihood; and/or (5) transmit the one or more recommendations to the computing device. In at least some embodiments, the subsequent time period may occur after the initial time period and prior to the end of the projected future time period.

Furthermore, aspects include the one or more recommendations being determined and transmitted only when at least one of the one or more home devices has a respective calculated likelihood of failure within the projected future time period that exceeds the threshold likelihood. These recommendations may include, for instance, replacing a part associated with the one or more home devices, cleaning the one or more home devices, scheduling an inspection of the one or more home devices, and/or performing preventative maintenance of the one or more home devices.

### Technical Advantages

The aspects described herein may be implemented as part of one or more computer components such as an EM device, one or more backend components, and/or as a home warranty assessment engine, for example. Furthermore, the aspects described herein may be implemented as part of a computer network architecture that facilitates communications between these, and other devices and/or components. Thus, the aspects described herein address and solve issues of a technical nature that are necessarily rooted in computer technology.

For instance, certain aspects include collecting home telematics data to generate an energy profile for various home devices, which may be analyzed to determine the overall health of these devices, and allow for a home warranty assessment engine to predict if and when a failure will occur. In doing so, the aspects overcome technical issues associated with attempting to remotely assess the overall condition of various home products. Without the improvements suggested herein, a person would need to physically visit a home and preform a time-consuming manual inspection of each home device. And even assuming that this was done, the energy profiles described herein indicate additional details associated with the electrical operation of home devices that may not be identified (or capable of being observed) via a manual inspection. For example, the transient electrical usage of a home device (i.e., upon initially being turned on) may indicate underlying problems that would not be detected via a manual inspection, which cannot identify such metrics.

Moreover, the use of home telematics data allows a home warranty provider to determine recommendations that, if carried out, may prevent predicted home device failures, thus potentially preventing costly and complex repairs. The use of energy profiles to identify and prioritize such recommendations solves technical issues related to remotely identifying the relevance of individual failures to a home warranty provider, and does so using detailed energy usage metrics that would not otherwise be available.

In doing so, the prioritization of preventative maintenance can be intelligently calculated and re-prioritized over time, which would otherwise require a person to periodically visit a home and manually perform detailed inspections. And again, even if this were to be done, a manual inspection would not reveal the same level of information regarding the operation, status, health, underlying issues, and likelihood of failure of the inspected devices.

Thus, the embodiments described herein improve upon existing technologies by accurately forecasting the failure of home devices in a manner that would otherwise not be feasible or practical. In addition to the technical issues addressed and improved upon by the techniques described herein, the various aspects also address existing issues related to the home warranty industry. For example, typically home warranties are issued without a home inspection and without knowledge of the overall health of the home devices to be covered by the warranty. Furthermore, nothing prevents people from only purchasing a home warranty when it is expected that a major home device will soon need to be repaired or replaced. Thus, the use of home telematics data advantageously allows a home warranty provider to mitigate risk when offering home warranty coverage.

### Additional Considerations

Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing.” “calculating,” “determining.” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112 (f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One may be implement numerous alternate embodiments, using either current technology or technology developed after the filing date of this application.

1. A computer-implemented method, comprising:
positioning an electricity monitoring hardware device including at least one processor adjacent or affixed to and in operative communication with an existing electrical distribution board, the electricity monitoring hardware device configured to simultaneously and continuously monitor electricity delivered from the existing electrical distribution board to a plurality of home devices;
correlating, by the electricity monitoring hardware device, detected unique electrical signatures from the monitored electricity to each of the plurality of home devices;
generating, by the electricity monitoring hardware device, home telematics data from the monitored electricity delivered over an initial time period as correlated with each of the plurality of home devices;
determining, via the one or more processors, a likelihood of whether each of the plurality of home devices will fail within a projected future time period based upon the monitored electricity in the home telematics data, the projected future time period occurring subsequent to the initial time period;
for each determined likelihood that exceeds a threshold likelihood, transmitting, via the one or more processors, each determined likelihood that exceeds the threshold likelihood and one or more recommendations to reduce each determined likelihood below the threshold likelihood to a computing device associated with a customer, thereby causing the computing device to display each determined likelihood that exceeds the threshold likelihood and the one or more recommendations; and
responding, via the one or more processors, to each of the respective determined likelihoods that does not exceed the threshold likelihood by:
collecting, via the one or more processors from the electricity monitoring hardware device, additional home telematics data over a subsequent time period, the additional home telematics data being indicative of electricity consumption of the plurality of home devices during the subsequent time period;
re-determining, via the one or more processors, the likelihood of whether each of the plurality of home devices will fail within the projected future time period based upon the additional home telematics data;
responding, via the one or more processors, to each redetermined likelihood that exceeds the threshold likelihood by transmitting, via the one or more processors, each respective redetermined likelihood that exceeds the threshold likelihood and one or more second recommendations configured to reduce each redetermined likelihood below the threshold likelihood to the computing device, thereby causing the computing device to display each redetermined likelihood that exceeds the threshold likelihood and the one or more second recommendations.

2. (canceled)

3. (canceled)

4. The method of claim 1, wherein the subsequent time period occurs after the initial time period and prior to an end of the projected future time period.

5. The method of claim 1, wherein the electricity monitoring hardware device is in wired communication with the existing electrical distribution board and detects the electricity flowing to each of the plurality of home devices as the plurality of home devices are powered by a home's electrical system.

6. The method of claim 1, wherein the one or more recommendations are determined and transmitted only when at least one of the plurality of home devices has a respective determined likelihood of failure within the projected future time period that exceeds the threshold likelihood.

7. The method of claim 1, wherein the one or more recommendations include one or more of:
replacing a part associated with one or more of the plurality of home devices;
cleaning one or more of the plurality of home devices;
scheduling an inspection of one or more of the plurality of home devices; and
performing preventative maintenance of one or more of the plurality of home devices.

8. A home warranty assessment engine, comprising:
a communication unit including at least one transceiver that is configured to collect home telematics data over an initial time period from an electricity monitoring hardware device including a processor removably adjacent or affixed to and in operative communication with an existing electrical distribution board, the electricity monitoring hardware device configured to simultaneously and continuously monitor electricity delivered from the existing electrical distribution board to a plurality of home devices covered by a home warranty, correlate, simultaneously and continuously, detected unique electrical signatures from the monitored electricity to each of the plurality of home devices, and generate the home telematics data from the monitored electricity delivered as correlated with each of the plurality of home devices; and
at least one processor that is configured to:
determine a likelihood of whether each of the plurality of home devices will fail within a projected future time period based upon the collected home telematics data, the projected future time period occurring subsequent to the initial time period;
determine whether each respective determined likelihood exceeds a threshold likelihood; and
for each determined likelihood that exceeds the threshold likelihood, transmit each determined likelihood that exceeds the threshold likelihood and one or more recommendations to reduce each determined likelihood below the threshold likelihood to a computing device associated with a customer having purchased the home warranty, thereby causing the computing device to display each determined likelihood that exceeds the threshold likelihood and the one or more recommendations; and
in response to each of the respective determined likelihoods that does not exceed the threshold likelihood:
cause the at least one transceiver to collect additional home telematics data from the electricity monitoring hardware device over a subsequent time period, the additional home telematics data being indicative of electricity consumption of the plurality of home devices during the subsequent time period,
redetermine the likelihood of whether each of the plurality of home devices will fail within the projected future time period based upon the additional home telematics data,
and
for each redetermined likelihood that exceeds the threshold likelihood, cause the at least one transceiver to transmit each respective redetermined likelihood that exceeds the threshold likelihood and [[the]] one or more second recommendations configured to reduce each redetermined likelihood below the threshold likelihood to the computing device, thereby causing the computing device to display each redetermined likelihood that exceeds the threshold likelihood and the one or more second recommendations.

9. (canceled)

10. (canceled)

11. The home warranty assessment engine of claim 8, wherein the subsequent time period occurs after the initial time period and prior to an end of the projected future time period.

12. The home warranty assessment engine of claim 8, wherein the electricity monitoring hardware device is in wired communication with the existing electrical distribution board and is configured to simultaneously detect the electricity flowing to each of the plurality of home devices as the plurality of home devices are powered by a home's electrical system.

13. The home warranty assessment engine of claim 8, wherein (i) the processor is further configured to determine the one or more recommendations, and (ii) the communication unit is further configured to transmit the one or more recommendations to the computing device, only when at least one of the plurality of home devices has a respective determined likelihood of failure within the projected future time period that exceeds the threshold likelihood.

14. The home warranty assessment engine of claim 8, wherein the one or more recommendations include one or more of:
replacing a part associated with one or more of the plurality of home devices;
cleaning one or more of the plurality of home devices;
scheduling an inspection of one or more of the plurality of home devices; and
performing preventative maintenance of one or more of the plurality of home devices.

15. A tangible, non-transitory, computer-readable medium storing instructions that, when executed by one or more processors, cause the one or more processors to be configured to:
collect home telematics data over an initial time period from an electricity monitoring hardware device including a processor removably positioned adjacent or affixed to and in operative communication with an existing electrical distribution board, the electricity monitoring hardware device configured to simultaneously and continuously monitor electricity delivered from the existing electrical distribution board to a plurality of home devices covered by a home warranty, correlate, simultaneously and continuously, detected unique electrical signatures from the monitored electricity to each of the plurality of home devices, and generate the home telematics data from the monitored electricity delivered as correlated with each of the plurality of home devices;
determine a likelihood of whether each of the plurality of home devices will fail within a projected future time period based upon the collected home telematics data, the projected future time period occurring subsequent to the initial time period;
determine whether each respective determined likelihood exceeds a threshold likelihood;
for each determined likelihood that exceeds the threshold likelihood, transmit each determined likelihood that exceeds the threshold likelihood and one or more recommendations to reduce each determined likelihood below the threshold likelihood to a computing device associated with a customer having purchased the home warranty, thereby causing the computing device to display each determined likelihood that exceeds the threshold likelihood and the one or more recommendations; and
respond to each of the respective determined likelihoods that does not exceed the threshold likelihood by:
collecting additional home telematics data from the electricity monitoring hardware device data over a subsequent time period, the additional home telematics data being indicative of electricity consumption of the plurality of home devices during the subsequent time period;
redetermining the likelihood of whether each of the plurality of home devices will fail within the projected future time period based upon the additional home telematics data; and
for each redetermined likelihood that exceeds the threshold likelihood,
transmitting each respective redetermined likelihood that exceeds the threshold likelihood and one or more second recommendations configured to reduce each redetermined likelihood below the threshold likelihood to the computing device, thereby causing the computing device to display each redetermined likelihood that exceeds the threshold likelihood and the one or more second recommendations.

16. (canceled)

17. (canceled)

18. The tangible, non-transitory, computer-readable medium of claim 15, wherein the subsequent time period occurs after the initial time period and prior to an end of the projected future time period.

19. The tangible, non-transitory, computer-readable medium of claim 15, wherein the electricity monitoring hardware device is in wired communication with the existing electrical distribution board and simultaneously detects the electricity flowing to each of the plurality of home devices as the plurality of home devices are powered by a home's electrical system.

20. The tangible, non-transitory, computer-readable medium of claim 15, wherein the instructions, when executed by one or more processors, further cause the one or more processors to be configured to determine the one or more recommendations, and transmit the one or more recommendations to the computing device only when at least one of the plurality of home devices has a respective determined likelihood of failure within the projected future time period that exceeds the threshold likelihood.

21. The method of claim 1, wherein the electricity monitoring hardware device is further configured to simultaneously and continuously detect electricity consumption data comprising time, duration, and magnitude of electricity consumption by each of the plurality of home devices, and combine the electricity consumption data with the home telematics data.
